(19) United States
(12) Patent Application Publication
(10) Pub. No.: US 2026/0076287 A1
(43) Pub. Date: Mar. 19, 2026

(54) Devices For Use In Treating Seeds, And Related Methods

(71) Applicant: Bayer CropScience LP, Saint Louis, MO (US)

(72) Inventors: Darrell Allen BASLER, Bloomsdale, MO (US); Bryan Patrick BRANNEKY, Saint Louis, MO (US); Damien Douglas BREWER, Creve Coeur, MO (US); Michael Francis MIGLIAZZO, Chesterfield, MO (US); Michael OSTENDORF, Leverkusen (DE); Rakulan SIVANESAPILLAI, Wuppertal (DE)

(21) Appl. No.: 19/110,054

(22) PCT Filed: Sep. 8, 2023
(86) PCT No.: PCT/US2023/032318

§ 371 Date: Mar. 7, 2025

Related U.S. Application Data
(60) Provisional application No. 63/405,754, filed on Sep. 12, 2022.

(51) Int. Cl. A01C 1/06

(52) U.S. Cl. CPC A01C 1/06

(57) ABSTRACT

Seed treatment devices and methods of treating seeds are provided. One example seed treatment device includes a mixing chamber in which seeds and a treatment formulation are mixed when received therein, a body having an inner surface defining at least part of the mixing chamber, a rotor having an inner surface defining at least a lower portion of the mixing chamber and configured to rotate to thereby cause the seeds in a lower portion of the mixing chamber to flow upwards along the inner surface of the rotor and the inner surface of the body, and one or more baffles. Each baffle includes a first concave surface configured to redirect the seeds and the treatment formulation when the rotor rotates in a first direction and a second concave surface configured to redirect the seeds and the treatment formulation when the rotor rotates in a second direction opposite the first direction.

### CROSS-REFERENCE TO RELATED APPLICATION

This application claims the benefit of, and priority to, U.S. Provisional Application No. 63/405,754, filed Sep. 12, 2022. The entire disclosure of the above application is incorporated herein by reference.

### FIELD

The present disclosure generally relates to devices for use in treating seeds (e.g., seed treatment devices (or seed treatment devices) for use in applying one or more treatment formulations to seeds, etc.) and to related methods of treating seeds, for example, using the devices.

### BACKGROUND

This section provides background information related to the present disclosure which is not necessarily prior art.

Seeds are often coated or treated with one or more active ingredients, such as biological or chemical agents, using a seed treatment device to enhance the seeds (e.g., improve viability, improve longevity, provide protection, etc.). Devices used to coat the seeds may be designed either for continuous or batch operation. Typically, a batch-type seed treating device includes a mixing chamber for receiving the seeds and a treatment formulation to be applied to the seeds, and baffles secured within the mixing chamber to facilitate mixing of the seeds and the treatment formulations. In other seed treating devices, baffles are retractable into and out of the mixing chamber via a lid covering the mixing chamber.

### SUMMARY

This section provides a general summary of the disclosure and is not a comprehensive disclosure of its full scope or all of its features.

Example embodiments of the present disclosure generally relate to seed treatment devices for use in applying treatment formulations to seeds. In some example embodiments, such a seed treatment device generally includes a rotor, a mixing chamber, and one or more baffles disposed in the mixing chamber. In connection therewith, in various embodiments, the one or more baffles include at least one baffle with concave surfaces facing toward an interior portion of the mixing chamber and configured to direct and/or redirect seeds and a seed treatment formulation in the mixing chamber when the rotor rotates.

In one example embodiment, such a seed treatment device generally includes a mixing chamber in which seeds and a seed treatment formulation are mixed when received therein, the mixing chamber having an interior portion and a vertical axis; a body including an inner surface defining at least part of the mixing chamber; a rotor positioned at least partly in the body and including an inner surface defining at least a lower portion of the mixing chamber, the rotor configured to rotate relative to the body about the vertical axis of the mixing chamber, to thereby cause the seeds in the lower portion of the mixing chamber to flow upwards along the inner surface of the rotor and along the inner surface of the body; a lid detachably coupled to the body and defined by a perimeter edge, the lid including an inner face surface adjacent to the mixing chamber when the lid is coupled to the body; and one or more baffles disposed in the mixing chamber. Each baffle includes a first concave surface and a second concave surface both facing at least partly toward the interior portion of the mixing chamber, the first concave surface configured to redirect the seeds and the treatment formulation in the mixing chamber toward the interior portion of the mixing chamber when the rotor rotates in a first direction and the second concave surface configured to redirect the seeds and the treatment formulation in the mixing chamber toward the interior portion of the mixing chamber when the rotor rotates in a second direction opposite the first direction.

Example embodiments of the present disclosure also generally relate to methods of treating seeds in a seed treatment device including a mixing chamber for mixing seeds and treatment formulations. One example method generally includes delivering seeds into a mixing chamber of the seed treatment device; rotating, relative to the body, the rotor in a first direction about the vertical axis, thereby causing the seeds within the mixing chamber to flow upward; delivering a seed treatment formulation into the mixing chamber, thereby treating the seeds with the seed treatment formulation; and rotating, relative to the body, the rotor in a second direction opposite the first direction about the vertical axis.

Further areas of applicability will become apparent from the description provided herein. The description and specific examples in this summary arc intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 is an exploded isometric view of an example embodiment of a seed treatment device of the present disclosure, for use in applying one or more seed treatments to seeds;

FIG. 2 is a side view of the seed treatment device of FIG. 1, as assembled with a lid positioned on a body;

FIG. 3 is a fragmentary front view of the assembled seed treatment device of FIG. 2;

FIG. 4 is a top isometric view of the body of the seed treatment device of FIG. 1;

FIG. 5 is a top isometric view of the lid of the seed treatment device of FIG. 1;

FIG. 6 is a top view of the lid of FIG. 5;

FIG. 7 is side view of the lid of FIG. 5;

FIGS. 8A-8D are various isometric views of a baffle of the lid of FIG. 5;

FIG. 9 is an exploded isometric view of a seed treating system including the seed treatment device of FIG. 1;

FIGS. 10-11 are isometric views of the seed treating system of FIG. 9;

FIG. 12 is a top isometric view of a portion of a seed treatment device of the present disclosure, where the seed treatment device includes a body and a baffle coupled to the body; and

FIG. 13 is a bottom view of a portion of the lid of FIG. 6.

Corresponding reference numerals indicate corresponding parts throughout the several views of the drawings.

### DETAILED DESCRIPTION

Seed treatment devices are used to mix seeds with a combination of active ingredients, for example, treatment formulations, thereby coating and treating the seeds with the active ingredients (or treatment formulations). The seed treatment devices often include baffles having fins to facilitate mixing of the seeds and treatment formulations. The fins, while sufficient to facilitate mixing of the seeds, however may cause build-up of seed treatment formulation within the mixing chamber, particularly adjacent to the fins. This build-up may then reduce productivity of the seed treatment devices by causing downtime, during which the seed treatment devices are cleaned to remove the seed treatment formulation build-up.

Uniquely, the seed treatment devices, systems and methods herein leverage baffles having concave surfaces to redirect seeds and treatment formulations in mixing chambers to help inhibit (e.g., substantially inhibit, etc.) the treatment formulations from building up within the mixing chamber and/or to help facilitate removal of any residual seed treatment formulation that does build-up within the mixing chambers. For example, the seed treatment devices, systems and methods herein utilize rotors configured to bidirectionally rotate and baffles having concave surfaces to mix and treat seeds with treatment formulations in the mixing chambers and to help inhibit/remove seed treatment formulation residue build-up within the mixing chambers, for example, when the rotors rotate in one or both directions. As such, production downtime for cleaning and removing build-up of treatment formulations in the mixing chambers may be decreased, and in some cases eliminated, as compared to conventional seed treatment devices.

Further, the seed treatment devices, systems and methods herein utilize a smaller number of baffles, with each having concave surfaces (for use in mixing and treating seeds), as compared to conventional seed treatment devices with traditional baffles due to, for example, the shape and bidirectional capabilities of the baffles herein. For instance, the seed treatment devices, systems and methods herein may rely on a single baffle, two baffles, three baffles, four baffles, etc. each having concave surfaces, whereas conventional seed treatment devices typically rely on upwards of twelve baffles. Due to the significant reduction of baffles, the surface area of the baffles that may require cleaning is greatly reduced as compared to conventional seed treatment devices. As such, any necessary cleaning of the devices herein to remove seed treatment formulation build-up may involve reduced surface areas to clean, and as a result, be more convenient, easier, and with significant time savings as compared to conventional seed treatment devices.

Example embodiments will now be described more fully with reference to the accompanying drawings. The description and specific examples included herein are intended for purposes of illustration only and are not intended to limit the scope of the present disclosure.

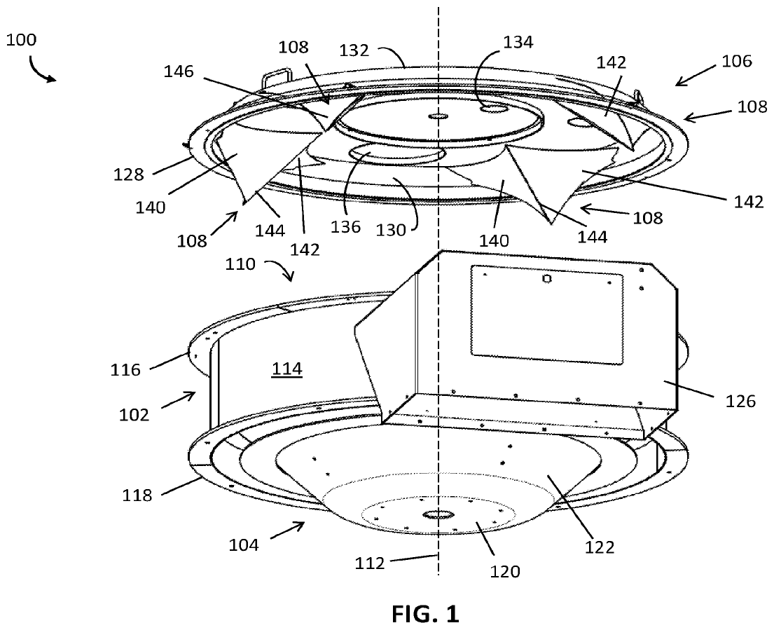

FIGS. 1-8D illustrate an example embodiment of a seed treatment device (or apparatus) 100 including one or more aspects of the present disclosure, for use in treating seeds and/or applying treatment formulations to seeds. The seed treatment device 100 may be used in a desired system for treating the seeds, for example, a batch seed treatment system such as a continuous batch seed treatment system, etc. That said, and as will be described, the seed treatment device 100 is configured (e.g., is constructed and operable, etc.) to cause rotation of a rotor, thereby mixing and treating seeds with a seed treatment formulation in a mixing chamber with baffles therein while inhibiting and/or removing seed treatment formulation residue build-up within the mixing chamber.

As shown in FIGS. 1-4, the illustrated seed treatment device 100 generally includes a stationary portion such as body (or stator) 102 and a rotating portion such as rotor 104 positioned in (or at least partly in) the body 102. The device 100 also generally includes a lid 106 configured to detachably (or removably) couple to the body 102, and baffles 108 disposed on (e.g., coupled to, etc.) the lid 106. The rotor 104 defines at least a portion (e.g., a lower portion, etc.) of a mixing chamber 110 in which seeds and a seed treatment formulation are mixed. As will be described, the baffles 108 are configured (e.g., are constructed, oriented, sized, etc.) to redirect seeds (via guides 111 (FIG. 3)) and a treatment formulation in the device 100 (within the mixing chamber 110), when the rotor rotates to move the seeds and treatment formulation, to thereby facilitate mixing of the seeds and coating of the seeds with the seed treatment formulation (e.g., on the seeds, around the seeds, etc.), Although the illustrated device 100 is shown and described as including four baffles 108, it should be appreciated that other numbers of baffles may be employed. For example, in other example embodiments, the device 100 may include one baffle, two baffles, three baffles, five baffles, six baffles, seven baffles, eight baffles, or more than eight baffles if desired.

The mixing chamber 110 (as generally defined by the body 102, the rotor 104, and the lid 106) includes a vertical axis 112 and an open interior portion in which seeds and a seed treatment formulation are mixed. For example, a portion of the rotor 104 may define a portion (e.g., a lower portion, etc.) of the mixing chamber 110, a portion of the body 102 may define a portion (e.g., an upper and/or side portion, etc.) of the mixing chamber 110, and the lid 106 may define a top portion of the mixing chamber 110 when the lid 106 is coupled to the body 102. In other embodiments, the mixing chamber 110 may be defined by different components and/or different portions of the body 102, the rotor 104, and the lid 106. In still other embodiments, the mixing chamber 110 may be defined by the rotor 104 and the lid 106.

The body 102 includes a generally cylindrical annular wall 114 that is generally coaxial with the vertical axis 112 of the mixing chamber 110, and upper and lower annular flanges 116, 118, respectively. The annular wall 114 has an annular inner surface and an annular outer surface, relative to the vertical axis 112. The annular flanges 116, 118 extend radially outward from upper and lower end portions, respectively, of the annular wall 114, and transverse to the vertical axis 112.

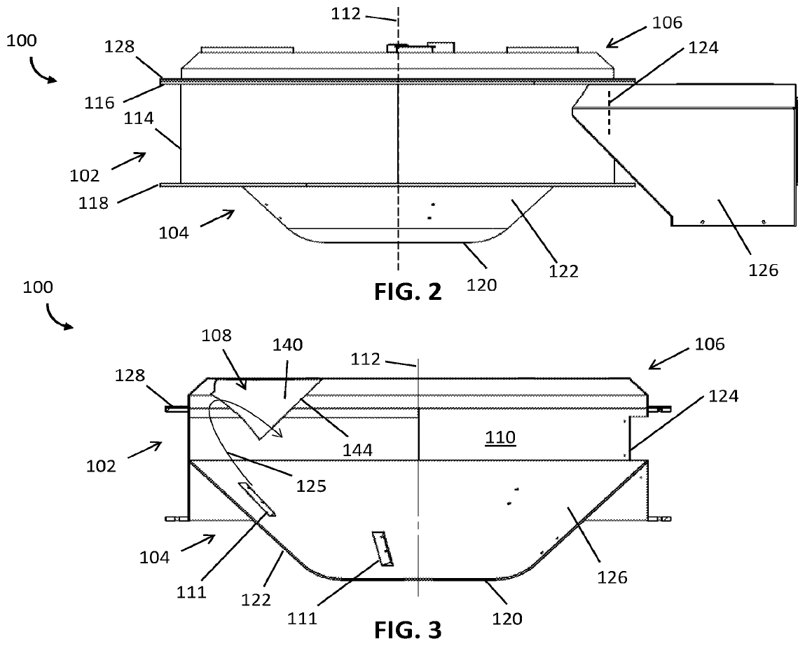

In the illustrated embodiment, the rotor 104 is positioned generally within the body 102 such as, for example, in a lower portion of the body 102. The rotor 104 includes an inner surface that is generally concave or bowl-shaped with a generally circular, planar base (or bottom) 120 and an angular or cone-shaped side wall 122. The guides 111 are positioned on the side wall 122. The base 120 of the rotor 104 extends radially outward from and generally transverse to the vertical axis 112. In some embodiments, the base 120 extends about ⅓ of the way to the annular wall 114 of the body 102 from the vertical axis 112, as shown in FIGS. 1-2.

In other embodiments, the base may extend at other distances. The cone-shaped side wall 122 of the rotor 104 extends from the base 120 towards the annular wall 114 of the body 102. For example, the side wall 122 extends circumferentially about the vertical axis 112 from the base 120 in a generally upward and radially outward direction toward the annular wall 114. In the illustrated embodiment, the angular side wall 122 extends toward about a midpoint of the annular wall 114 (e.g., an upper end of the side wall 122 of the rotor 104 is about halfway between the upper and lower ends of the annular wall 114 of the body 102, etc.), such that an upper portion of the body 102 is above the rotor 104 and defines an upper portion of the mixing chamber 110.

In the illustrated embodiment, the angular side wall 122 of the rotor 104 is in a close-fitting relationship with the annular wall 114 of the body 102 such that seeds and/or treatment formulation cannot pass between the rotor 104 and body 102. In some embodiments, the angular side wall 122 of the rotor 104 and the annular wall 114 for the body 102 may be scaled to each other, and/or a gasket may be posited therebetween to inhibit seeds and/or treatment formulation cannot pass between the rotor 104 and body 102. Although the body 102 and the rotor 104 are described as having annular shaped walls, it should be appreciated that the body 102 and rotor 104 may have other shapes and configurations than described herein that are within the scope of the present disclosure.

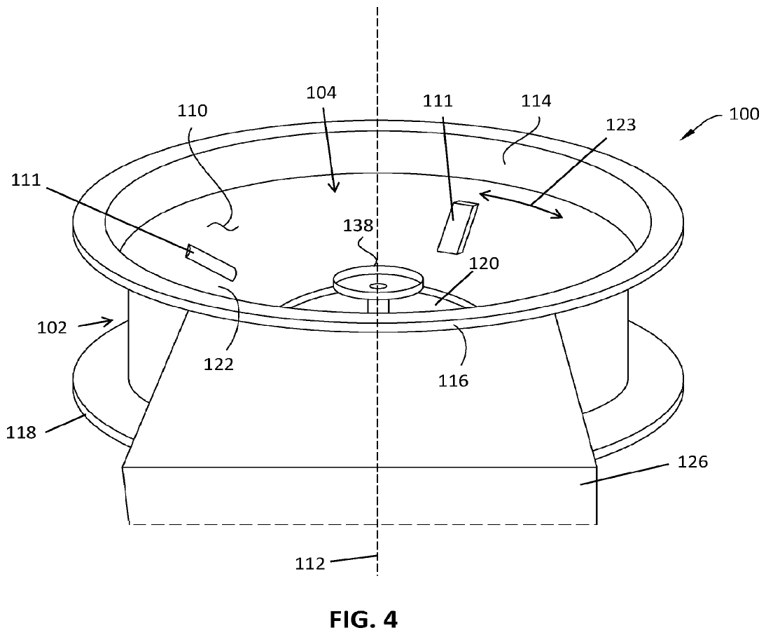

The rotor 104 is configured to rotate relative to the body 102 and about the vertical axis 112 of the mixing chamber 110 (as generally indicated by arrow 123 in FIG. 4). For example, a driver may be coupled to the rotor 104 and configured to drive 360 degree rotation of the rotor 104 about the vertical axis 112 (e.g., rotational axis, etc.) relative to the body 102 and the lid 106. The driver may include a motor, such as an electric motor, configured to cause the rotor 104 to rotate and a controller configured to control rotation (e.g., speed, direction, etc.) of the rotor 104.

In some embodiments, the rotor 104 is configured to bidirectionally rotate (as also generally indicated by the double sided arrow 123 in FIG. 4). In other words, the rotor 104 may be configured to rotate in a first direction or a second direction opposite the first direction. In such examples, the direction of rotation of the rotor 104 may be controlled by reversing a polarity of the motor actuating the rotor 104.

For example, the rotation of the rotor 104 in either direction may cause the guides 111 (e.g., based on an angular arrangement of the guides 111, etc.) to direct seeds and a seed treatment formulation in the lower portion of the mixing chamber 110 to flow upwards along the inner surface of the rotor 104 (e.g., along the wall 122, etc.) and along the inner surface of the body 102 (e.g., along the wall 114, etc.) toward the lid 106, where the seeds and the seed treatment formulation engage the baffles and are redirected by the baffles 108 generally inwardly and downwardly with respect to the mixing chamber 110 (as indicated by arrow 125 in FIG. 3). As a result, the seeds and the seed treatment formulation mix, thereby coating the seeds with the seed treatment formulation. In some examples, the rotor 104 may then be rotated in a second, opposite direction. Such opposite rotation may, for example, cause the seeds within the mixing chamber 110 to again flow upwards along the inner surface of the rotor 104 (via the guides 111) and the inner surface of the body 102 (in an opposite direction), where the seeds are again redirected by the baffles 108 generally inwardly and downwardly with respect to the mixing chamber 110. In doing so, the reverse movement of the seeds in the mixing chamber 110 may also facilitate removal of seed treatment formulation residue within the mixing chamber 110 (remaining or built up (e.g., on opposite sides of the baffles 108, etc.) from movement of the seeds and treatment formulation in the prior direction) and cleaning of the mixing chamber 110 (while at the same time also further mixing the seeds and the seed treatment formulation (and further facilitating coating of the seeds with the seat treatment formulation)).

In some embodiments, the rotation of the rotor 104 in either direction to mix the seeds and the seed treatment formulation may constitute a seed treatment. The rotor 104 may then be rotated in the second, opposite direction after a predetermined number of seed treatments to facilitate removal of any built-up or accumulated treatment formulation in the mixing chamber 110. For example, the process of loading, delivering, etc. seeds and a seed treatment formulation into the mixing chamber 110, and then rotating the rotor 104 in either direction to mix the seeds and the seed treatment formulation may be implemented multiple times. Due to the configuration of the baffles 108 (further explained below), seed treatment formulation residue build-up may be substantially prevented and/or minimized herein. However, as a precautionary measure or if build-up does occur, the rotor 104 may be rotated in the second, opposite direction after a predetermined number of seed treatments, to thereby at least partly remove seed treatment formulation residue within the mixing chamber 110 (e.g., clean the mixing chamber 110, etc.). The predetermined number of seed treatments may depend on various conditions such as, for example, the type of seeds being treated, how the seeds are treated, the weather (e.g., humidity, temperature, etc.) during the treatment(s) and/or a desired amount of seed treatment cycles deemed appropriate by a user,

In other examples, the rotor 104 may be rotated in the second, opposite direction based on observation of the mixing chamber 110. For instance, a user may inspect the mixing chamber 110 after a predetermined number of seed treatments, such as one seed treatment, three seed treatments, five seed treatments, ten seed treatments, etc. If the user observes some seed treatment formulation residue build-up (e.g., more than a threshold level, etc.) (e.g., around or adjacent the baffles 108, at other locations within the mixing chamber 110, etc.), the rotor 104 may be controlled to rotate in the second, opposite direction, to thereby remove seed treatment formulation residue within the mixing chamber 110 (e.g., clean the mixing chamber 110, etc.).

With continued reference to FIGS. 1-4, the body 102 of the seed treatment device 100 defines an exit opening 124 in the upper portion thereof. The exit opening 124 is configured to allow the seeds to exit, discharge from, etc. the mixing chamber 110 after the treatment formulation has been applied to the seeds (e.g., the exit opening is, broadly, in fluid communication with the mixing chamber 110; etc.) regardless of the direction of rotation of the rotor 104. In various embodiments, a door may be configured to cover the exit opening 124 and open to accommodate the seeds exiting, discharging from, etc. the mixing chamber 110 when the seeds are flowing in either direction. In such examples, the door may pivot (e.g., via a hinge positioned on top of, above, etc. the exit opening 124) up and down. In addition, the exit opening 124 is in communication with a seed collector 126 for receiving the seeds exiting the mixing chamber 110. In some embodiments, a door (not shown) may be configured to close the exit opening 124 while the seeds and treatment formulation are being mixed together in the mixing chamber 110. The door may be selectively operable, such as by a controller, etc.

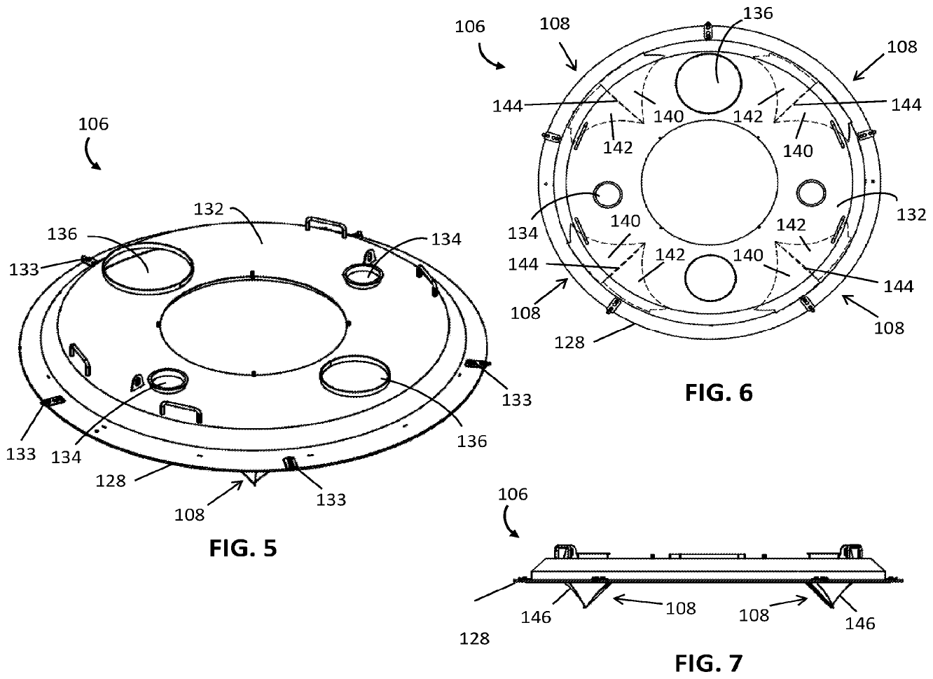

With additional reference to FIGS. 5-7, the lid 106 is generally defined by an annular perimeter edge 128 and includes an inner face surface 130 adjacent to the mixing chamber 110 when the lid 106 is coupled to the body 102 and an outer face surface 132 opposing the inner surface 130. The annular perimeter edge 128 of the lid 106 is generally shaped and sized to correspond to the shape and size of the body 102 (e.g., the upper annular flange 116 of the body 102, etc.). The face surfaces 130, 132 are generally circular in shape and extend circumferentially about the vertical axis 112.

The lid 106 is configured to be releasably coupled (e.g., mounted, secured, etc.) on the body 102 over an open upper end of the mixing chamber 110. For example, the lid 106 may be releasably coupled to the body 102 with multiple clamps 133. That said, it should be appreciated that other suitable mechanical attachment devices may be fixed to the upper flange 116 of the body 102 and/or the perimeter edge 128 of the lid 106 and used to couple the lid 106 to the body 102. When the lid 106 is coupled to the body 102, the lid 106 overlies and engages the upper flange 116 of the body 102 and covers the open upper end of the interior portion of the mixing chamber 110, thereby enclosing the mixing chamber 110.

In the illustrated embodiment, the lid 106 defines multiple inlet openings 134, 136 for receiving or otherwise allowing the ingress of seed stock, treatment composition, finishing powders, and/or any additional materials used in a treatment process into the mixing chamber 110. In such examples, the inlet openings 134, 136 are in fluid communication with the mixing chamber 110. For example, the lid 106 includes the inlet openings 134 configured to receive a seed treatment formulation (e.g., a liquid, a slurry, a powder, granules, etc.), and the inlet openings 136 configured to receive seeds. In such examples, seeds and a seed treatment formulation may be loaded, delivered, etc. into the mixing chamber 110 via the inlet openings 134, 136.

In some embodiments, the device 100 may include a seed loading chute (not shown) in communication with one or both of the inlet openings 136 of the lid 106. The seed loading chute may be configured to direct seeds into the mixing chamber 110 via the inlet opening(s) 136. In one embodiment, the seed loading chute may include a lid configured to be removed such that seeds can be placed into the seed loading chute and directed (e.g., fall, etc.) into the mixing chamber 110. In such examples, the device 100 may further include a seed delivery device (not shown) in communication with the seed loading chute for automatically delivering seeds to the seed loading chute. For example, an auger or other type of seed delivery device may be disposed above the chute. The seed delivery device may be controlled by a controller, etc.

Additionally, the device 100 may include a seed treatment applicator with a portion that extends into the mixing chamber 110 via, for example, one or both of the inlet openings 134 or another opening. In such examples, the seed treatment applicator may be configured to dispense the seed treatment formulation into the mixing chamber 110. For example, the seed treatment applicator may dispense the seed treatment formulation while the rotor 104 is stationary or rotating. Accordingly, the seed treatment applicator may dispense treatment formulation onto the seeds while the seeds are stationary or flowing within the mixing chamber 110. The seed treatment applicator may be fluidly connected to a source of seed treatment formulation (not shown). A pump or other mover may then be incorporated with the source of seed treatment formulation to deliver the treatment to the seed treatment applicator. The seed treatment applicator may be configured to deliver any suitable fluid or fluidizable treatment substance. For example, the seed treatment applicator may be configured to deliver one or more of a treatment formulation that is a liquid, a slurry, a powder, etc., examples of which are described below. The seed treatment applicator may also be configured to deliver two or more different treatments simultaneously.

In the illustrated embodiment, the seed treatment applicator includes a rotating plate 138 (as shown in FIG. 4) near the center of the mixing chamber 110 and configured to radially throw the treatment formulation onto the seeds. The rotating plate 138 may be driven or otherwise controlled by a controller (e.g., and operated via the driver used to rotate the rotor 104, etc.). Other configurations of the seed treatment applicator are within the scope of the present disclosure. For example, the seed treatment applicator may dispense the treatment into the mixing chamber 110 via a sprayer, curtain, sheet, or fan that can create a more uniform and faster initial distribution of treatment formulation between seeds than, for example, a rotating plate. For example, in one embodiment, the seed treatment applicator may include a spray applicator configured to spray the seeds that have spread out over the surfaces defining the mixing chamber (e.g., onto a bed of the seeds, etc.) via the centrifugal forces imparted by the rotor 104 to achieve a more uniform initial distribution of treatment formulation. Still, in another embodiment, the seed treatment applicator may include multiple treatment distribution heads (e.g., treatment outlets, etc.) that extend into the seeds contained within the mixing chamber 110 (e.g., into the seed volume, etc.) and deliver the seed treatment formulation directly into the seed volume. Such a seed treatment applicator may be desirable in large treatment loading conditions (such as 50 or more fluid ounces of treatment per 100 lbs. of seed, etc.) to achieve a high degree of initial seed-to-seed treatment uniformity. A more uniform initial distribution of treatment formulations between seeds results in a more uniform final distribution of treatment formulation over the seeds when the seed treating process (e.g., mixing and drying, etc.) is completed. Other configurations of the seed treatment applicator are within the scope of the present disclosure. Moreover, other devices for delivering treatments are also possible.

In the illustrated embodiment, the baffles 108 are coupled to the lid 106 and are disposed in the mixing chamber 110 when the lid is coupled to the body 102. The baffles 108 are configured (e.g., constructed, etc.) to redirect seeds and a treatment formulation in the device 100 when the rotor 104 rotates, to thereby facilitate mixing of the seeds and coating of the seed treatment formulation on the seeds and/or removal of any seed treatment formulation residue build-up within the mixing chamber 110. For instance, the baffles 108 may be shaped, sized, etc. (as explained below) in a manner conducive of catching the seeds and the treatment formulation and forcing/directing the seeds and the treatment formulation downward towards a bottom portion of the mixing chamber 110, to thereby facilitate mixing of the seeds and coating of the seed treatment formulation on the seeds and/or removal of seed treatment formulation residue in the mixing chamber 110. In some examples, each baffle 108 may have substantially the same shape (e.g., a pyramidical shape, etc.), while in other examples one or more of the baffles 108 may have different shapes from other ones of the baffles, if desired.

For example, and as shown in FIGS. 1, 3, and 5-8D, each baffle 108 includes fins 140, 142 having (or defining) generally concave surfaces facing generally toward the interior portion of the mixing chamber 110 and generally toward fins 140, 142 of adjacent ones of the baffles 108. For instance, the concave surface of fin 140 of one baffle 108 faces generally toward the interior portion of the mixing chamber 110 and also generally toward the concave surface of fin 142 of an adjacent baffle 108, and the concave surface of fin 142 of the one baffle 108 faces generally toward the interior portion of the mixing chamber 110 and generally toward the concave surface of fin 140 of another adjacent baffle 108, as shown. In this manner, the concave surfaces of the fins 140, 142 may be viewed as generally facing away from each other.

The concave surfaces of the fins 140, 142 of each baffle 108 define a radius of curvature for catching the seeds and the treatment formulation (as they move upward in the mixing chamber 110) and forcing, directing (or redirecting), etc. the seeds and the treatment formulation back downward towards the bottom portion of the mixing chamber 110 (to thereby establish a circulating flow of seeds and treatment formulation within the mixing chamber 110). For example, the concave surfaces of the fins 140, 142 may have a radius of curvature of between about 25 percent and about 60 percent of a radius of curvature of the inner surface of the body 102. More specifically, the concave surfaces of the fins 140, 142 may have a radius of curvature of about 25 percent, about 30 percent, about 40 percent, about 50 percent, about 60 percent, and/or any other percent therebetween of a radius of curvature of the inner surface of the body 102. Such radius of curvature may help direct the seeds in a desired flow path in the mixing chamber 110 and may also help inhibit build up of treatment formulation during treatment processes.

In some embodiments, the concave surfaces of the fins 140, 142 may have different radi of curvature for different sections of each surface. For instance, one or both concave surface of one or more of the fins 140, 142 may include multiple sections forming a compound surface. In such examples, the multiple sections may intersect at one or more edges of the baffle 108. In other examples, the multiple sections may form one generally smooth surface with a series of varying radii of curvature. The multiple sections may include, for example, two or more sections.

Additionally, each baffle 108 includes an edge 144 and the concave surface of each fin 140, 142 adjoins along the edge 144. In the illustrated embodiment, then, the fins 140, 142 (and concave surfaces) of each baffle 108 are mirrored relative to the edge 144. In other words, the concave surfaces of the fins 140, 142 of each baffle 108 may be symmetrical surfaces relative to the edge 144 (e.g., with the edge 144 serving as a center edge, etc. for the symmetry; etc.). As such, in the illustrated embodiment, each baffle 108 has a generally pyramidical shape (e.g., with one fin 140 generally defining one side of the paramedical shape and the other fin 142 generally defining another side of the pyramidical shape, etc.). Although the baffles 108 are each shown as having mirrored concave surfaces 140, 142 forming the same pyramidical shape, it should be appreciated that one or more of the baffles 108 may have differently configured concave surfaces. For example, one or more of the baffles 108 may include concave surfaces having different shapes and/or sizes. In such examples, the baffles 108 may not include mirrored concave surfaces and/or may not be symmetrical.

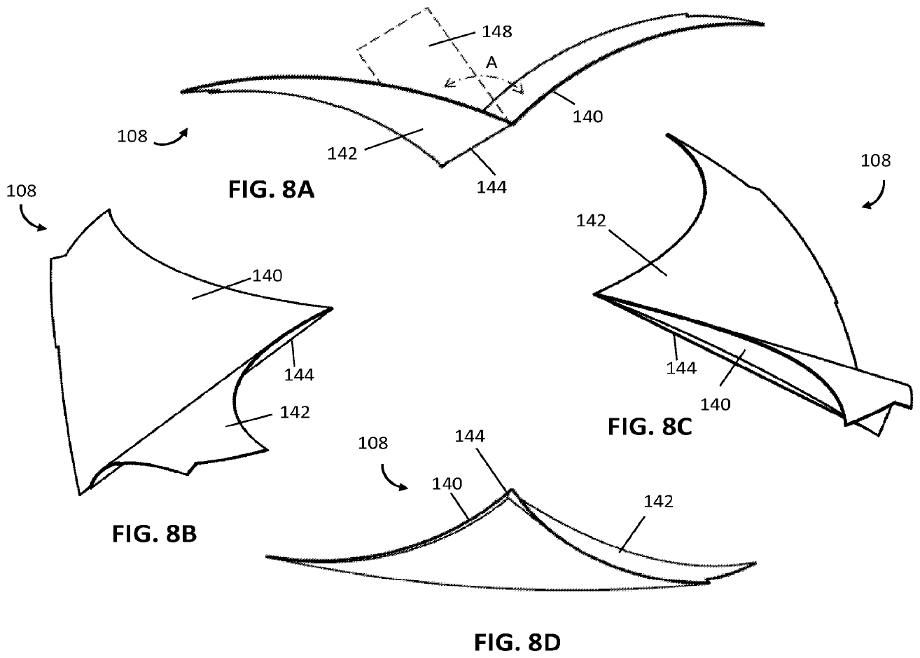

The concave surface of the fins 140, 142 define an inclination angle relative to the edge 144. For example, and with reference to FIG. 8A, a bisecting plane 148 (shown with dashed lines) passing through the edge 144 (e.g., along the point of intersection of the concave surfaces of the fins 140, 142; etc.) may be used as a reference. In such examples, the concave surface of each fin 140, 142 may define an angle relative to the bisecting plane 148 (as disposed at the point of intersection, or edge 144). For instance, in the example of FIG. 8A, the concave surface of the fin 140 and the bisecting plane 148 define an angle A therebetween. In various embodiments, the angle between the bisecting plane 148 and each fin 140, 142 may be between about 10 degrees and about 90 degrees. More specifically, the inclination angle relative to the plane may be about 35 degrees, about 45 degrees, about 55 degrees, about 65 degrees, about 70 degrees, about 75 degrees, about 80 degrees, about 85 degrees, about 90 degrees, and/or any other amount therebetween. Further, the angle defined between the bisecting plane 148 and the fin 140 may be the same as or different from the angle defined between the bisecting plane 148 and the fin 142.

In some embodiments, the edge 144 of each baffle 108 may be inclined relative to the vertical axis 112 of the mixing chamber 110 by any suitable degree. For example, the edge 144 of each baffle 108 may be inclined relative to the vertical axis 112 by between 15 degrees and 45 degrees. More specifically, the edge 144 of each baffle 108 may be angled relative to the vertical axis 112 by about 15 degrees, about 30 degrees, about 45 degrees, and/or any other amount therebetween. The angle of the edge 144 relative to the vertical axis 112 may at least partially define the radius of curvature of the concave surfaces of the fins 140, 142.

Further, the baffles 108 may have a desired circumferential width. For example, the circumferential width at maximum endpoints of each baffle 108 may be approximately between about 45 percent and about 70 percent of a radius of curvature or a mean radius of curvature of the edge 144 of the baffle 108. More specifically, the circumferential width may be about 45 percent, about 50 percent, about 55 percent, about 60 percent, about 65 percent, about 70 percent, and/or any other amount therebetween of a radius of curvature or a mean radius of curvature of the edge 144 of the baffle 108.

In other embodiments, the circumferential width at maximum endpoints of each baffle 108 may be based on (e.g., a ratio of, etc.) a diameter of the inner surface of the body 102. Using the diameter of the inner surface of the body 102 as a reference for the circumferential widths of the baffles 108 may assist in making the baffles 108 occupy a substantial portion of the surface of the body 102. As a result, a small amount (e.g., two baffles, four baffles, etc.) of larger baffles 108 may be employed rather than many smaller baffles (e.g., twelve baffles, etc.). In various embodiments, the ratio of the circumferential width at maximum endpoints of each baffle 108 to the diameter of the inner surface of the body 102 may range from about 40% to 75%, including any suitable value therebetween such as 45%, 50%, 55%, 60% 65%, 70%, etc.

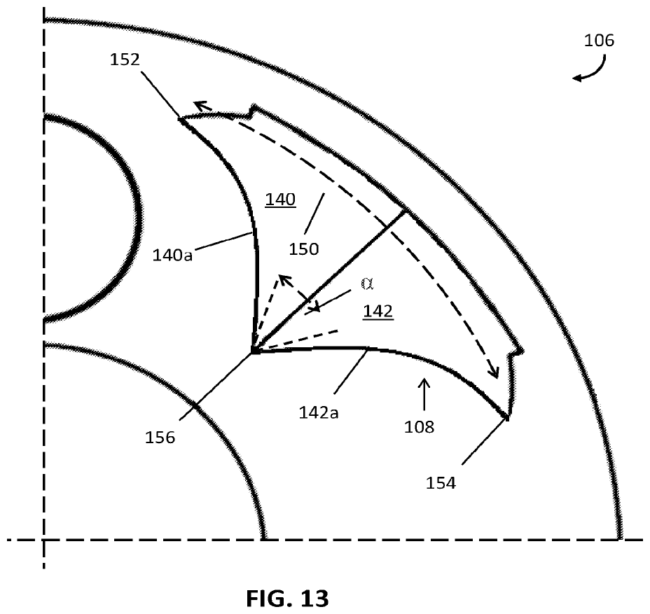

FIG. 13 illustrates an example embodiment of the lid 106 including one of the baffles 108. In the example of the FIG. 13, the circumferential width of the baffle 108 may be defined as being the circumferential distance (e.g., along the dashed double arrow line 150) between two end points of the baffle 108. In FIG. 13, the endpoints are maximum endpoints 152, 154 of the baffle 108 (e.g., opposing points of the baffle 108 at a maximum distance apart, etc.). In addition in this example embodiment, concave surfaces 140a, 142a of the fins 140, 142 of the illustrated baffle 108 define a generally rounded shape have a radius of curvature. In one example, the radius of curvature of the concave surfaces 140a, 142a may each be defined by a circle have a radius R, where a center point of the circle defining the radius of curvature of the concave surface 140a is spaced apart from the circle defining the radius of curvature of the concave surface 142a by a distance L. In this example, then, the distance L may be defined as 2Rcos(α/2), where α is an internal angle between the fins 140, 142 as measured generally at (or toward) tip 156 of the baffle 108 (e.g., two times the angle A defined between the concave surface of the fin 140/142 and the bisecting plane 148 as shown in FIG. 8A, etc.).

As shown, in the illustrated embodiment the baffles 108 are generally equally spaced about the lid 106 and, thus, in the mixing chamber 110. In such examples, the baffles 108 may be spaced about the mixing chamber 110 with clearances for the inlet openings 134, 136 in the lid 106. For example, the baffles 108 may be spaced circumferentially at about every 90 degrees around the lid 106 and in the mixing chamber 110, as shown, e.g., in FIG. 6 (where the baffles 108 are generally indicated by dashed lines). In other examples, the baffles 108 may be spaced differently (e.g., not equally spaced or equally spaced at other angles, etc.) depending on, for example, the number of baffles 108 employed, the shape and/or size of the baffles 108, etc.

In some embodiments, the space between each baffle 108 and the inner surface of the body 102 may be sufficiently small to prevent seeds from passing therebetween. For instance, each baffle 108 may include a rear surface 146 generally opposing the concave surfaces of the fins 140, 142. The rear surface 146 of each baffle 108 and the inner surface of the body 102 then define a clearance (e.g., a distance between the rear surface 146 and the inner surface of the body 102) having a width smaller than a smallest dimension (e.g., a smallest average dimension) of the seeds. In other embodiments, the baffles 108 may not include a rear surface adjacent to the inner surface of the body 102. In such examples, the fins 140, 142 of each baffle 108 and the inner surface of the body 102 may define a clearance (e.g., a distance between each fin 140, 142 and the inner surface of the body 102) having a width smaller than the smallest dimension (e.g., the smallest average dimension) of the seeds. Further, in some examples, the width of the clearance between the rear surface 146 of each baffle 108 or each fin 140, 142 and the inner surface of the body 102 may be no greater than one half of the smallest dimension (e.g., smallest average dimension) of the seeds. In this manner, construction of the baffles 108 and the arrangement of the baffles within the mixing chamber 110 provide minimal (if any) locations for treatment formulation (and seeds) to stick, accumulate, and/or build up during treatment processes.

In various embodiments, the smallest dimension of the seeds may differ depending on the type of seeds employed. For example, the smallest dimension of a seed may be its diameter if the seed is spherical. In other examples, the smallest dimension of a seed may be its thickness, length or width if the seed is not spherical. For instance, some corn seeds may have a length of between about 10 mm and about 12 mm (between about 0.4 inches and about 0.47 inches), a width of between about 6 mm and about 9 mm (between about 0.236 inches and about 0.354 inches), and a thickness of between about 4 mm and about 6 mm (between about 0.157 inches and about 0.236 inches), and some soybean seeds may have a narrowest dimension of between about 4 mm and about 6 mm (between about 0.157 inches and about 0.236 inches). In such examples, the width of the clearance between the rear surface 146 of each baffle 108 or each fin 140, 142 and the inner surface of the body 102 may be about 3 mm or less (e.g., about 3 mm, about 2 mm, about 1 mm, about 0.5 mm or another suitable value therebetween; etc.).

The baffles 108 may be disposed in the mixing chamber 110 in any suitable manner. For example, in the illustrated embodiment the baffles 108 are coupled (e.g., detachably coupled, etc.) to the inner surface 130 of the lid 106. In such example, each baffle 108 may be positioned adjacent to the perimeter edge 128 of the lid 106 or another suitable location along the lid 106. As such, in this embodiment, the concave surfaces of the fins 140, 142 of each baffle 108 face generally away from the inner surface 130 of the lid 106, and toward the interior portion of the mixing chamber 110.

In various embodiments, the baffles 108 are configured to provide a smooth transition for the seeds when the seeds move in the mixing chamber 110. This smooth transition may be provided, for example, by the shape of the baffles relative to other components of the device 100. For example, when the baffles 108 are coupled to the lid 106, an inclination angle of the concave surfaces of the fins 140, 142 of each baffle 108 may be any suitable value. For example, the concave surfaces of the fins 140, 142 of each baffle 108 may have an inclination angle of about 30 degrees or less relative to the inner surface 130 of the lid 106, of about 20 degrees or less relative to the inner surface 130 of the lid 106, etc. More specifically, the inclination angle of the concave surfaces of the fins 140, 142 relative to the inner surface 130 of the lid 106 may be about 15 degrees, about 10 degrees, about 5 degrees, about 1 degree, and/or any other amount therebetween. In this manner, the seeds may smoothly transition from the lid 106 or another component in the device 100 to the baffles 108 and/or from the baffles to the lid 106 or another component in the device 100 without crashing into the baffles 108, the lid 106, etc. and spraying into undesirable flow paths.

In other embodiments, one or more of the baffles 108 may be coupled (e.g., detachably coupled, etc.) to a surface of another component of the device 100. For example, each (or less than each) of the baffles 108 may be coupled to the inner surface of the body 102. In such examples, the baffles 108 may be positioned adjacent to the upper portion of the body 102 (e.g., near the upper flanges 116 of the body 102, etc.) or another suitable location along the body 102. As such, in this embodiment, the concave surfaces of the fins 140, 142 of each baffle 108 face away from the inner surface of the body 102, and toward the interior portion of the mixing chamber 110.

In these embodiments, the baffles 108 are configured to provide a smooth transition for the seeds when the seeds move in the mixing chamber 110 based on, for example, the shape of the baffles relative to other components of the device 100, as explained above. For example, when the baffles 108 are coupled to the body 102, an inclination angle of the concave surfaces of the fins 140, 142 of each baffle 108 may be any suitable value. For example, the concave surfaces of the fins 140, 142 of each baffle 108 may have (or may define) an inclination angle of about 30 degrees or less relative to the inner surface of the body 102, about 20 degrees or less relative to the inner surface of the body 102, etc. More specifically, the inclination angle of the concave surfaces of the fins 140, 142 relative to the inner surface of the body 102 may be about 15 degrees, about 10 degrees, about 5 degrees, about 1 degree, and/or any other amount therebetween. In this manner, the seeds may smoothly transition from the inner surface of the body 102 to the baffles 108 and/or from the baffles 108 to the inner surface of the body 102 without crashing into the baffles 108, the inner surface of the body 102, etc. and spraying into undesirable flow paths.

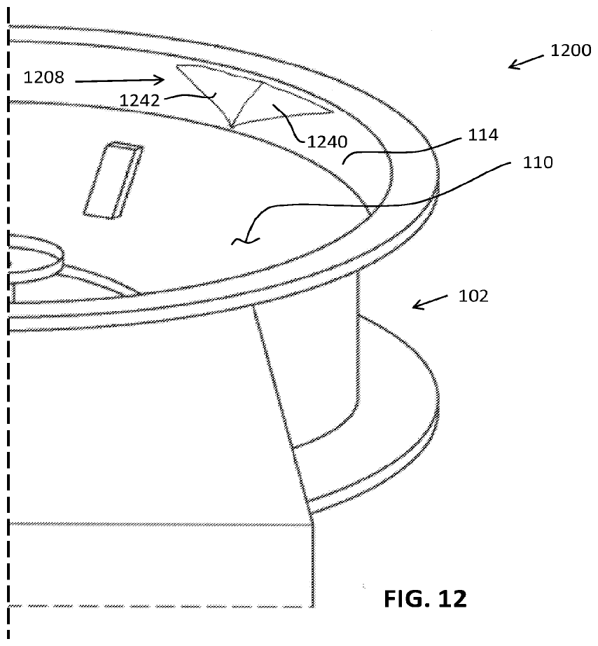

FIG. 12 illustrates an example embodiment of a seed treatment device (or apparatus) 1200 substantially similar to the device 100 of FIGS. 1-4, but where a baffle 1208 is coupled to an inner surface of the body 102. More specifically, in the example of FIG. 12, the baffle 1208 is coupled to the annular wall 114 of the body 102.

In some embodiments, the baffle 1208 of FIG. 12 is substantially similar to the baffles 208 of FIGS. 1-8. For example, the baffle 1208 may include similar features and characteristics as explained herein relative to the baffles 208. More specifically, and as shown in FIG. 12, the baffle 1208 includes fins 1240, 1244 having concave surfaces. In the embodiment of FIG. 12, the concave surfaces of the fins 1240, 1244 face away from the annular wall 114 of the body 102, and toward the interior portion of the mixing chamber 110.

In the example of FIG. 12, only a portion of the seed treatment device 1200 is illustrated. As such, it should be appreciated that additional baffles (e.g., similar to the baffle 1208) may be spaced apart along the annular wall 114 of the body 102. For example, the seed treatment device 1200 may include two baffles, three baffles, five baffles, six baffles, seven baffles, eight baffles, or more than eight baffles spaced apart along the annular wall 114 of the body 102.

In various embodiments, the baffles 108, 1208 may be detachably coupled to the inner surface 130 of the lid 106, the inner surface of the body 102, and/or another suitable component of the device 100 in any suitable manner. For example, the baffles 108, 1208 may be detachably coupled to a particular component of the device 100 with adhesive, a magnet, a lap joint, and/or another suitable attachment device, material, etc.

Further, the baffles 108, 1208 may be formed of any suitable material. For instance, the fins 140, 142 of the baffles 108 may be formed of a suitable sheet material, such as sheet metal, a plastic, etc.

Although the baffles 108, 1208 are shown and described as having particularly configured (e.g., shaped, positioned, etc.) concave surfaces (e.g., as part of fins 140, 142; etc.), it should be appreciated that other configurations of the baffles may be implemented without departing from the scope of the present disclosure. For example, each of the concave surfaces (e.g., the fins) may have another suitable design, shape, and/or configuration to facilitate mixing of the seeds and coating of the seed treatment formulation on the seeds and/or removal of seed treatment formulation residue build-up within the mixing chamber 110 as explained herein.

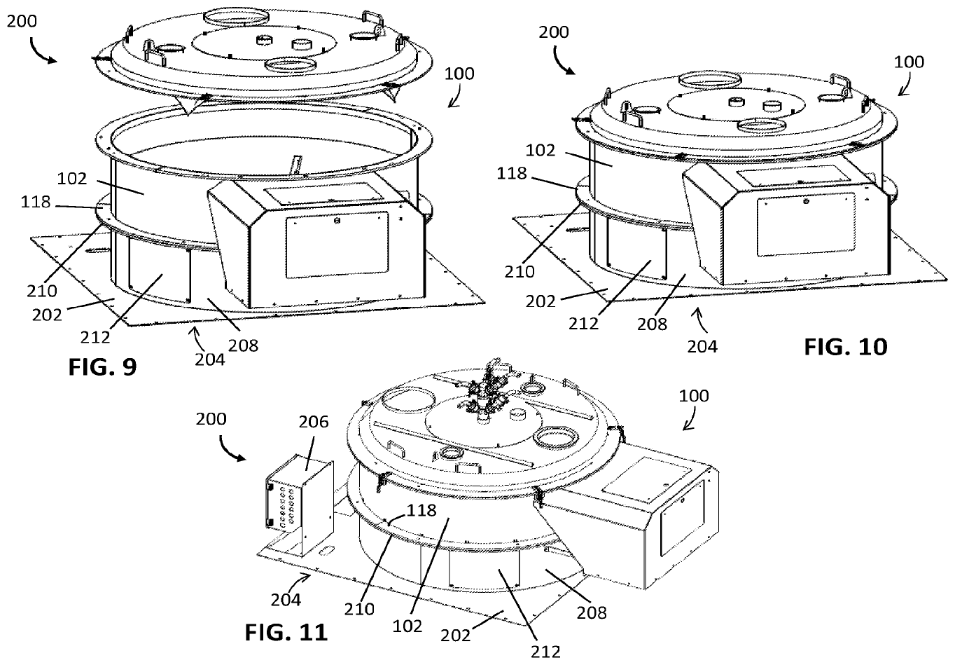

FIGS. 9-11 illustrate an example embodiment of a seed treatment system 200 (e.g., a batch seed treatment device system, such as a continuous batch seed treatment device system; etc.) including one or more aspects of the present disclosure. As shown, the illustrated seed treatment system 200 generally includes the device 100 of FIGS. 1-8, a support 202, a housing 204 coupled between the support 202 and the device 100, and a controller 206 coupled to the support 202

The housing 204 includes a generally cylindrical annular wall 208 that is coaxial with the vertical axis of the mixing chamber 110 in the device 100 and an upper annular flange 210. The annular flange 210 extends radially outward from an upper end of the annular wall 208 and transverse to the mixing chamber's vertical axis. The annular flange 210 is shaped and sized to correspond to the annular flange 118 of the body 102.

As shown, one end of the housing 204 is coupled (e.g., detachably coupled, etc.) to the body 102 of the device 100. For example, the annular flange 210 of the housing 204 may be releasably coupled to the annular flange 118 of the body 102 with multiple pins, screws, bolts, clamps and/or other suitable mechanical attachment devices. The other opposing end of the housing 204 may be coupled (e.g., detachably coupled, etc.) to the support 202 (e.g., a metal plate, etc.) via in any suitable manner (e.g., one or more mechanical attachment devices, etc.).

The controller 206 may be configured to control rotation (e.g., speed, direction, etc.) of the rotor in the device 100. For example, the controller 206 may be configured to control a motor 212 (or another suitable driver), thereby causing the rotor to rotate in either direction (as described above). As a result, seeds and a seed treatment formulation in the device 100 may flow upwards along the inner surface of the rotor and then downwards due to the baffles (not shown), thereby mixing the seeds and the seed treatment formulation and coating the seeds with the seed treatment formulation and/or removing seed treatment formulation residue build-up.

Additionally, the controller 206 may be configured to control other components of the system 200. For examples, the controller 206 may be configured to selectively open/close a door associated with the exit opening of the body 102, to control a seed delivery device for automatically delivering seeds to the device 100, to control a seed treatment applicator (e.g., the rotating plate 138 of the device 100), etc.

The controller 206 may be any suitable type of control device. For example, in some embodiments, the controller may include a processor and memory coupled to (and in communication with) the processor. For example, the processor may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein. The memory may be one or more devices that permit data, instructions, etc., to be stored therein and retrieved therefrom. For example, the memory may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. Furthermore, in various embodiments, computer-executable instructions may be stored in the memory for execution by the processor to cause the processor to perform one or more of the operations described herein in connection with the various different parts of or in communication with the device 100 and/or the system 200, such that the memory is a physical, tangible, and non-transitory computer readable storage media.

In various embodiments, the seed treatment devices and/or systems herein may be implemented in various seed treatment and/or cleaning processes. For example, the seed treatment device 100 of FIGS. 1-8 (and/or any other seed treatment device herein) may be configured to mix (e.g., agitate, etc.) the seeds and treatment formulation received in, delivered to, loaded into, etc. the mixing chamber 110 to apply, coat, etc. (e.g., evenly, substantially evenly, etc.) the treatment formulation to substantially all of the seeds in the device 100. Seed-to-seed mixing is accomplished by the random contact between seeds and the relative seed motion caused by the rotation of the rotor 104 and the concave surfaces of the fins 140, 142 of the baffles 108 redirecting the flowing seeds. In doing so, a recirculating seed circulation path (e.g., flow of seeds, etc.) extends radially outward from the vertical axis 112 (e.g., the rotational axis, etc.) in all directions along the concave surface of the rotor 104 toward the body 102. More specifically, the recirculating seed circulation path extends upward along the generally concave surface of the rotor 104 (e.g., as generally directed by the guides 111, etc.), along the concave surfaces of the fins 140, 142, and then downward toward the base 120 (e.g., bottom, etc.) of the rotor 104 at an inward location spaced from the annular wall.

By employing the baffles 108 with the fins 140, 142 having the concave surfaces, a velocity of the seed and treatment formulation mixture traveling along the seed circulation path may be maintained above a desired level. For example, it may be desirable to maintain the seed mixture velocity above about one m/sec for a substantial majority of the seeds. For instance, about 90% or more of the seeds may have a mixture velocity above about one m/sec, about 95% or more of the seeds may have a mixture velocity above about one m/sec, or even about 99% or more of the seeds may have a mixture velocity above about one m/sec. The seed mixture velocity may also be adjusted by changing the frequency signal sent to the rotor actuation motor using a variable frequency drive (VFD). However, the most efficient way to achieve a seed mixture velocity above about one m/sec for a substantial majority of the seeds is to employ the baffles 108 in conjunction with treatment formulation mixture that is not excessively cohesive. Testing has shown that the seed treatment device bodies herein employing baffles with the concave surfaces are able to maintain an average mixture velocity of above about one m/sec, above about one and a half m/sec, above about two m/sec, above about two and a half m/sec, etc.

In one example of a seed treatment process, seed is first loaded, delivered, etc. into the seed treatment device 100. This may occur while the rotor 104 is rotating or before the rotor 104 is rotated. After a period of time of rotating the quantity of seeds (e.g., about 1 second to about 10 seconds), a mixture (e.g., liquid, etc.), or subset thereof, of the seed treatment formulation is applied, delivered, etc. to the seeds (e.g., manually into the mixing chamber 110, automatically by the seed treatment source and the seed treatment applicator as explained herein, etc.). When the rotor 104 is rotating, portions of the seeds and seed treatment formulation contact corresponding ones of the concave surfaces (e.g., the concave surfaces of the fins 140, etc.) of the baffles 108 (but not the other ones of the concave surfaces (e.g., not the concave surfaces of the fins 142, etc.), which in turn redirects the seeds and seed treatment formulation generally inward and generally downward relative to the mixing chamber 110.

After mixing, the treated seed may be discharged from the mixing chamber 110. More specifically, the treated seed may be discharged via the exit opening 124 regardless of the direction of rotation of the rotor 104, as explained herein. In various embodiments, the baffles 108 may accelerate the discharge of treated seeds from the mixing chamber 110. For example, conventional seed treatment devices include a large number of baffles such as over a dozen baffles for diverting seeds in respective seed flow patterns for mixing purposes. Such aggregate seed flow patterns limit the rate of seed egress at the end of a batch mixing cycle. As such, due to the reduced number of baffles employed in the seed treatment devices, systems and methods herein as compared to conventional devices, less seed flow patterns may be relied on in a mixing cycle. In connection therewith, a higher average seed velocity and a higher rate of seed egress may be achieved as compared to conventional devices.

In some examples, pressurized air or another suitable fluid from a source may be provided to the mixing chamber 110 during mixing. The flow of forced fluid is generally in the same direction as the flow of seeds during mixing. This may assist in mixing the seeds and the seed treatment formulation, moving the seeds and the seed treatment formulation to prevent residue build-up, etc. The pressurized air may also be used during discharge of the seeds to facilitate the flow of seeds out of the mixing chamber 110.

Additionally, in various embodiments, multiple seed treatment formulations may be applied, delivered to, etc. the mixing chamber 110. For instance, after an initial seed treatment formulation is applied, the process may deliver a second seed treatment formulation, which may be based on a prior determination, an interruption of the treatment sequence by process feedback, etc. The second seed treatment formulation may be the same or different than the first seed treatment formulation. For example, the subsequent treatment formulation may include finishing agents, polymeric binders. Etc. After mixing of the secondary treatment components (e.g., between about 5 seconds after application and about 10 seconds after application), the treated seed may be discharged.

In some embodiments, the delivering of seeds, rotation of the rotor 104, and the delivering of the seed treatment formulation may constitute a seed treatment. After the completion of the seed treatment, the process may include rotating, relative to the body 102, the rotor 104 in a second opposite direction. Rotation in the opposite direction may be provided by reversing a polarity of a motor actuating the rotor. Due to the opposing rotation of the rotor 104, seeds move in an opposite direction within the mixing chamber 110 and contact the other concave surface (e.g., the concave surfaces of fins 142, etc.) of the baffles 108. With the rotation in the opposite direction, the movement of the seeds in the generally opposite direction within the mixing chamber 110 may remove seed treatment formulation residue that built up, or accumulated (e.g., that accumulated on the concave surfaces of the fins 142, etc.), during the rotation of the seeds in the prior direction within the mixing chamber 110.

Rotation of the rotor 104 in the opposite direction may be initiated in various manners. For example, the rotor 104 may be rotated in the second, opposite direction after a predetermined number of seed treatments, based on observation of the mixing chamber 110, etc. as explained above.

In some embodiments, the seed treatment formulation herein may include a seed treatment active, such as a biological agent and/or agrochemical. For example, the seed treatment formulation may include a seed-finishing agent suitable for enhancing one or more physical properties of the exterior surfaces of the seeds. The seed treatment formulations may be applied in a dry state or a wet state (e.g., slurry). After being contacted by the seed treatment active, for purposes herein, the seeds are referred to as treated seeds.

In some embodiments, the seed treatment active may include one or more pesticidal agents. Pesticidal agents may include chemical pesticides and biopesticides or biocontrol agents. Various types of chemical pesticides and biopesticides may include acaricides, insecticides, nematicides, fungicides, gastropodicides, herbicides, virucides, bactericides, and combinations thereof. Biopesticides or biocontrol agents may include bacteria, fungi, beneficial nematodes, and viruses that exhibit pesticidal activity.

Non-limiting examples of chemical acaricides, insecticides, and/or nematicides may include one or more carbamates, diamides, macrocyclic lactones, neonicotinoids, organophosphates, phenylpyrazoles, pyrethrins, spinosyns, synthetic pyrethroids, tetronic acids and/or tetramic acids. Non-limiting examples of chemical acaricides, insecticides and nematicides that can be useful in compositions of the present disclosure include abamectin, acrinathrin, aldicarb, aldoxycarb, alpha-cypermethrin, betacyfluthrin, bifenthrin, cyhalothrin, cypermethrin, deltamethrin, esfenvalerate, etofenprox, fenpropathrin, fenvalerate, flucythrinate, fosthiazate, lambda-cyhalothrin, gamma-cyhalothrin, permethrin, tau-fluvalinate, transfluthrin, zeta-cypermethrin, cyfluthrin, bifenthrin, tefluthrin, eflusilanat, fubfenprox, pyrethrin, resmethrin, imidacloprid, acetamiprid, thiamethoxam, nitenpyram, thiacloprid, dinotefuran, clothianidin, chlorfluazuron, diflubenzuron, lufenuron, teflubenzuron, triflumuron, novaluron, flufenoxuron, hexaflumuron, bistrifluoron, noviflumuron, buprofezin, cyromazine, methoxyfenozide, tebufenozide, halofenozide, chromafenozide, endosulfan, fipronil, ethiprole, pyrafluprole, pyriprole, flubendiamide, chlorantraniliprole (e.g., Rynaxypyr), cyazypyr, emamectin, emamectin benzoate, abamectin, ivermectin, milbemectin, lepimectin, tebufenpyrad, fenpyroximate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozinc, flonicamid, pyriproxyfen, diofcnolan, chlorfenapyr, metaflumizone, indoxacarb, chlorpyrifos, spirodiclofen, spiromesifen, spirotetramat, pyridalyl, spinctoram, acephate, triazophos, profenofos, oxamyl, spinetoram, fenamiphos, fenamipclothiahos, 4-{[(6-chloropyrid-3-yl)methyl](2,2-difluoroethyl)amino}furan-2(5H)-one, 3,5-disubstituted-1,2,4-oxadiazole compounds, 3-phenyl-5-(thien-2-yl)-1,2,4-oxadiazole, cadusaphos, carbaryl, carbofuran, ethoprophos, thiodicarb, aldicarb, aldoxycarb, metamidophos, methiocarb, sulfoxaflor, methamidophos, cyantraniliprole and tioxazofen and combinations thereof. Additional non-limiting examples of chemical acaricides, insecticides, and/or nematicides may include one or more of abamectin, aldicarb, aldoxycarb, bifenthrin, carbofuran, chlorantraniliporle, chlothianidin, cyfluthrin, cyhalothrin, cypermethrin, cyantraniliprole, dinotefuran, emamectin, ethiprole, fenamiphos, fipronil, flubendiamide, fosthiazate, imidacloprid, ivermectin, lambda-cyhalothrin, milbemectin, nitenpyram, oxamyl, permethrin, spinetoram, spinosad, spirodichlofen, spirotetramat, tefluthrin, thiacloprid, thiamethoxam, tioxazofen and/or thiodicarb, and combinations thereof.

Additional non-limiting examples of acaricides, insecticides and nematicides that may be included or used in seed treatment formulations in some embodiments may be found in Steffey and Gray, Managing Insect Pests, ILLINOIS AGRONOMY HANDBOOK (2008); and Niblack, Nematodes, ILLINOIS AGRONOMY HANDBOOK (2008), the contents and disclosures of which are incorporated herein by reference. Non-limiting examples of commercial insecticides which may be suitable for the seed treatment formulations disclosed herein include CRUISER (Syngenta, Wilmington, Delware), GAUCHO and PONCHO (Gustafson, Plano, Texas). Active ingredients in these and other commercial insecticides may include thiamethoxam, clothianidin, and imidacloprid. Commercial acaricides, insecticides, and/or nematicides may be used in accordance with a manufacturer's recommended amounts or concentrations.

In some embodiments, the seed treatment active may include one or more biopesticidal agents the presence and/or output of which is toxic to an acarid, insect and/or nematode. For example, the seed treatment active may include one or more of Bacillus firmus 1-1582, Bacillus mycoides AQ726, NRRL B-21664; Beauveria bassiana ATCC-74040, Beauveria bassiana ATCC-74250, Burkholderia sp. A396 sp. Nov. rinojensis, NRRL B-50319, Chromobacterium subtsugae NRRL B-30655, Chromobacterium vaccinii NRRL B-50880, Flavobacterium H492, NRRL B-50584, Metarhizium anisopliae F52 (also known as Metarhizium anisopliae strain 52, Metarhizium anisopliae strain 7, Metarhizium anisopliae strain 43, and/or Metarhizium anisopliae BIO-1020, TAE-001; deposited as DSM 3884, DSM 3885, ATCC 90448, SD 170 and ARSEF 7711), Paecilomyces fumosoroseus FE991, and combinations thereof.

Non-limiting examples of chemical fungicides may include one or more aromatic hydrocarbons, benzthiadiazole, carboxylic acid amides, morpholines, phenylamides, phosphonates, thiazolidines, thiophene, quinone outside inhibitors and strobilurins, such as azoxystrobin, coumethoxystrobin, coumoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, 2-[2-(2,5-dimethyl-phenoxymethyl)-phenyl]-3-methoxy-acrybc acid methyl ester, and 2-(2-(3-(2,6-dichlorophenyl)-1-methyl-allylideneaminooxymethyl)-phenyl)-2-methoxyimino-N-methyl-acetamide, carboxamides, such as carboxanilides (e.g., benalaxyl, benalaxyl-M, benodanil, bixafen, boscabd, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(4′-trifluoromethylthiobiphenyl-2-yl)-3-difluoromethyl-1-methyl-1H-pyra-zole-4-carboxamide, N-(2-(1,3,3-trimethylbutyl)-phenyl)-1,3-dimethyl-5-fluoro-IH-pyrazole-4-carboxamide), carboxylic morpholides (e.g., dimethomorph, flumorph, pyrimorph), benzoic acid amides (e.g., flumetover, fluopicolide, fluopyram, zoxamide), carpropamid, dicyclomet, mandiproamid, fenehexamid, oxytetracyclin, silthiofam, and N-(6-methoxy-pyridin-3-yl) cyclopropanecarboxylic acid amide, spiroxamine, azoles, such as triazoles (e.g., azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole) and imidazoles (e.g., cyazofamid, imazalil, pefurazoate, prochloraz, triflumizol); heterocyclic compounds, such as pyridines (e.g., fluazinam, pyrifenox (cf. Dlb), 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine), pyrimidines (e.g., bupirimatc, cyprodinil, diflumctorim, fcnarimol, ferimzone, mepanipyrim, nitrapyrin, nuarimol, pyrimethanil), piperazines (e.g., triforine), pyrroles (e.g., fenpiclonil, fludioxonil), morpholines(e.g., aldimorph, dodemorph, dodemorph-acetate, fenpropimorph, tridemorph), piperidines (e.g., fenpropidin); dicarboximides (e.g., fluoroimid, iprodione, procymidone, vinclozolin), non-aromatic 5-membered heterocycles (e.g., famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester), acibenzolar-S-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo-[1,5-a]pyrimidine; benzimidazoles, such as carbendazim; and other active substances, such as guanidines (e.g., guanidine, dodine, dodine free base, guazatine, guazatine-acetate, iminoctadine), iminoctadine-triacetate and iminoctadine-tris(albesilate); antibiotics (e.g., kasugamycin, kasugamycin hydrochloride-hydrate, streptomycin, polyoxine and validamycin A), nitrophenyl derivates (e.g., binapacryl, dicloran, dinobuton, dinocap, nitrothal-isopropyl, tecnazen). Organometal compounds (e.g., fentin salts, such as fentin-acetate, fentin chloride, fentin hydroxide); sulfur-containing heterocyclyl compounds (e.g., dithianon, isoprothiolane), organophosphorus compounds (e.g., edifenphos, fosetyl, iprobenfos, phosphorus acid and its salts, pyrazophos, tolclofos-methyl), organochlorine compounds (e.g., chlorothalonil, dichlofluanid, dichlorophen, flusulfamide, hexachlorobenzene, pencycuron, pentachlorphenole and its salts, phthalide, quintozene, thiophanate-methyl, thiophanates, tolylfluanid, N-(4-chloro-2-nitro-phenyl)-N-ethyl-4-methyl-benzenesulfonamide) and inorganic active substances (e.g., Bordeaux mixture, copper acetate, copper hydroxide, copper oxychloride, basic copper sulfate, sulfur) and combinations thereof. In an aspect, the seed treatment active comprises comprise acibenzolar-S-methyl, azoxystrobin, benalaxyl, bixafen, boscabd, carbendazim, cyproconazole, dimethomorph, epoxiconazole, fludioxonil, fluopyram, fluoxastrobin, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, prothioconazole, pyraclostrobin, sedaxane, silthiofam, tebuconazole, thiabendazole, thifluzamide, thiophanate, tolclofos-methyl, trifloxystrobin and triticonazole, and combinations thereof.

Additional examples of fungicides that may be included in the seed treatment active formulations in some embodiments may be found, for example, in Bradley, Managing Diseases, ILLINOIS AGRONOMY HANDBOOK (2008), the content and disclosure of which are incorporated herein by reference. Fungicides useful for seed treatment formulations in some embodiments may include compounds that exhibit activity against one or more fungal plant pathogens, including but not limited to Phytophthora, Rhizoctonia, Fusarium, Pythium, Phomopsis, Selerotinia or Phakopsora, and combinations thereof. Non-limiting examples of commercial fungicides which may be suitable for the seed treatment formulations in some embodiments include PROTÈGÈ, RIVAL or ALLEGIANCE FL or LS (Gustafson, Plano, Texas), WARDEN RTA (Agrilance, St. Paul, Minnesota), APRON XL, APRON MAXX RTA or RFC, MAXIM 4FS or XL (Syngenta, Wilmington, Delaware), CAPTAN (Arvesta, Guelph, Ontario) and PROTREAT (Nitragin Argentina, Buenos Ares, Argentina). Active ingredients in these and other commercial fungicides include, but are not limited to, fludioxonil, mefenoxam, azoxystrobin and metalaxyl. Commercial fungicides may be used in accordance with a manufacturer's recommended amounts or concentrations.

In some embodiments, the seed treatment active may include one or more biopesticidal agents the presence and/or output of which is toxic to at least one fungus and/or bacteria. For example, the seed treatment active may include one or more of Ampelomyces quisqualis AQ 10® (Intrachem Bio GmbH & Co. KG, Germany), Aspergillus flavus AFLA-GUARD® (Syngenta Crop Protection, Inc., CH), Aureobasidium pullulans BOTECTOR® (bio-ferm GmbH, Germany), Bacillus pumilus AQ717 (NRRL B-21662), Bacillus pumilus NRRL B-30087, Bacillus AQ175 (ATCC 55608), Bacillus AQ177 (ATCC 55609), Bacillus subtilis AQ713 (NRRL B-21661), Bacillus subtilis AQ743 (NRRL B-21665), Bacillus amyloliquefaciens FZB24, Bacillus amyloliquefaciens FZB42, Bacillus amyloliquefaciens NRRL B-50349, Bacillus subtilis ATCC 55078, Bacillus subtilis ATCC 55079, Bacillus thuringiensis AQ52 (NRRL B-21619), Candida oleophila 1-182 (e.g., ASPIRE® from Ecogen Inc., USA), Candida saitoana BIOCURE® (in mixture with lysozyme; BASF, USA) and BIOCOAT® (ArystaLife Science, Ltd., Cary, NC), Clonostachys rosea f. catenulata (also referred to as Gliocladium catenulatum) J1446 (PRESTOP®, Verdera, Finland), Coniothyrium minitans CONTANS® (Prophyta, Germany), Cryphonectria parasitica (CNICM, France), Cryptococcus albidus YIELD PLUS® (Anchor Bio-Technologies, South Africa), Fusarium oxysporum BIOFOX® (from S.I. A.P. A., Italy) and FUSACLEAN® (Natural Plant Protection, France), Metschnikowia fructicola SHEMER® (Agrogreen, Israel), Microdochium dimerum ANTIBOT® (Agrauxine, France), Muscodor albus NRRL 30547, Muscodor roseus NRRL 30548, Phlebiopsis gigantea ROTSOP® (Verdera, Finland), Pseudozyma flocculosa SPORODEX® (Plant Products Co. Ltd., Canada), Pythium oligandrum DV74 (POLYVERSUM®, Remeslo SSRO, Biopreparaty, Czech Rep.), Reynoutria sachlinensis (e.g., REGALIA® from Marrone BioInnovations, USA), Streptomyces NRRL B-30145, Streptomyces M1064, Streptomyces galbus NRRL 30232, Streptomyces lydicus WYEC 108 (ATCC 55445), Streptomyces violaceusniger YCED 9 (ATCC 55660; DE-THATCH-9®, DECOMP-9® and THATCH CONTROL®, Idaho Research Foundation, USA), Streptomyces WYE 53 (ATCC 55750; DE-THATCH-9®, DECOMP-9® and THATCH CONTROL®, Idaho Research Foundation, USA), Talaromyces flavus VI 17b (PROTUS®, Prophyta, Germany), Trichoderma asperellum SKT-1 (ECO-HOPE®), Kumiai Chemical Industry Co., Ltd., Japan), Trichoderma atroviride LC52 (SENTINEL®, Agrimm Technologies Ltd, NZ), Trichoderma harzianum T-22 (PLANTSHIELD®, der Firma BioWorks Inc., USA), Trichoderma harzianum TH-35 (ROOT PRO®, from Mycontrol Ltd., Israel), Trichoderma harzianum T-39 (TRICHODEX®, Mycontrol Ltd., Israel; TRICHODERMA 2000®, Makhteshim Ltd., Israel), Trichoderma harzianum ICC012 and Trichoderma viride TRICHOPEL (Agrimm Technologies Ltd, NZ), Trichoderma harzianum ICC012 and Trichoderma viride ICC080 (REMEDIER® WP, Isagro Ricerca, Italy), Trichoderma polysporum and Trichoderma harzianum (BINAB®, BINAB Bio-Innovation AB, Sweden), Trichoderma stromaticum TRICOVAB® (C.E. P.L. A.C., Brazil), Trichoderma virens GL-21 (SOILGARD®, Certis LLC, USA), and combinations thereof.

In some embodiments, the seed treatment active may include one or more suitable chemical herbicides. The herbicides may be a pre-emergent herbicide, a post-emergent herbicide, or a combination thereof. Non-limiting examples of chemical herbicides may include one or more acetyl CoA carboxylase (ACCase) inhibitors, acetolactate synthase (ALS) inhibitors, acetanilides, acetohydroxy acid synthase (AHAS) inhibitors, photosystem II inhibitors, photosystem I inhibitors, protoporphyrinogen oxidase (PPO or Protox) inhibitors, carotenoid biosynthesis inhibitors, enolpyruvylshikimate-3-phosphate (EPSP) synthase inhibitors, glutamine synthetase inhibitors, dihydropteroate synthetase inhibitors, mitosis inhibitors, 4-hydroxyphenyl-pyruvate-dioxygenase (4-HPPD) inhibitors, synthetic auxins, auxin herbicide salts, auxin transport inhibitors, nucleic acid inhibitors and/or one or more salts, esters, racemic mixtures and/or resolved isomers thereof. Non-limiting examples of chemical herbicides that can be useful in compositions of the present disclosure include 2,4-dichlorophenoxyacetic acid (2,4-D), 2,4,5-trichlorophenoxyacetic acid (2,4,5-T), ametryn, amicarbazone, aminocyclopyrachlor, acetochlor, acifluorfen, alachlor, atrazine, azafenidin, bentazon, benzofenap, bifenox, bromacil, bromoxynil, butachlor, butafenacil, butroxydim, carfentrazone-ethyl, chlorimuron, chlorotoluro, clethodim, clodinafop, clomazone, cyanazine, cycloxydim, cyhalofop, desmedipham, desmetryn, dicamba, diclofop, dimefuron, diflufenican, diuron, dithiopyr, ethofumesate, fenoxaprop, foramsulfuron, fluazifop, fluazifop-P, flufenacet, fluometuron, flufenpyr-ethyl, flumiclorac, flumiclorac-pentyl, flumioxazin, fluoroglycofen, fluthiacet-methyl, fomesafen, glyphosate, glufosinate, halosulfuron, haloxyfop, hexazinone, iodosulfuron, indaziflam, imazamox, imazaquin, imazethapyr, ioxynil, isoproturon, isoxaflutole, lactofen, linuron, mecoprop, mecoprop-P, mesosulfuron, mesotrion, metamitron, metazochlor, methibenzuron, metolachlor (and S-metolachlor), metoxuron, metribuzin, monolinuron, oxadiargyl, oxadiazon, oxaziclomefone, oxyfluorfen, phenmedipham, pretilachlor, profoxydim, prometon, prometm, propachlor, propanil, propaquizafop, propisochlor, propoxycarbazone, pyraflufen-ethyl, pyrazon, pyrazolynate, pyrazoxyfen, pyridate, quizalofop, quizalofop-P (e.g., quizalofop-ethyl, quizalofop-P-ethyl, clodinafop-propargyl, cyhalofop-butyl, diclofop-methyl, fenoxaprop-P-ethyl, fluazifop-P-butyl, haloxyfop-methyl, haloxyfop-R-methyl), saflufenacil, sethoxydim, siduron, simazine, simetryn, sulcotrione, sulfentrazone, tebuthiuron, tembotrione, tepraloxydim, terbacil, terbumeton, terbuthylazine, thaxtomin (e.g., the thaxtomins described in U.S. Pat. No. 7,989,393), thiencarbazone-methyl, thenylchlor, tralkoxydim, triclopyr, trietazine, trifloxysulfuron, tropramezone, salts and esters thereof; racemic mixtures and resolved isomers thereof and combinations thereof. In an embodiment, seed treatment active compositions comprise acetochlor, clethodim, dicamba, flumioxazin, fomesafen, glyphosate, glufosinate, mesotrione, quizalofop, saflufenacil, sulcotrione, S-3100 and/or 2,4-D, and combinations thereof.

Additional examples of herbicides that may be included in seed treatment formulations in some embodiments may be found in Hager, Weed Management, Illinois Agronomy Handbook (2008); and Loux et al., Weed Control Guide for Ohio, Indiana and Illinois (2015), the contents and disclosures of which are incorporated herein by reference. Commercial herbicides may be used in accordance with a manufacturer's recommended amounts or concentrations.

In various embodiments, the seed treatment active may include one or more biopesticidal agents the presence and/or output of which is toxic to at least one plant, including for example, weeds. Examples of biopesticides that may be included or used in compositions in some embodiments may be found in BURGES, supra; HALL & MENN, BIOPESTICIDES: USE AND DELIVERY (Humana Press) (1998); McCoy et al., Entomogenous fungi, in CRC HANBOOK OF NATURAL PESTICIDES. MICROBIAL PESTICIDES, PART A. ENTOMOGENOUS PROTOZOA AND FUNGI (C.M. Inoffo, ed.), Vol. 5:151-236 (1988); SAMSON et al., ATLAS OF ENTOMOPATHOGENIC FUNGI (Springer-Verlag, Berlin) (1988); and deFaria and Wraight, Mycoinsecticides and Mycoacaricides: A comprehensive list with worldwide coverage and international classification of formulation types, BIOL. CONTROL (2007), the contents and disclosures of which are incorporated herein by reference.

In some embodiments, the seed treatment active may include one or more additional agent. For example, the seed treatment active may include one or more beneficial biostimulants and/or microbial inoculants. Biostimulants or inoculants may enhance ion uptake, nutrient uptake, nutrient availability or delivery, or a combination thereof. Non limiting examples of biostimulants or inoculants that may be included or used in compositions may include bacterial extracts (e.g., extracts of one or more diazotrophs, phosphate-solubilizing microorganisms and/or biopesticides), fungal extracts, humic acids (e.g., potassium humate), fulvic acids, myo-inositol, and/or glycine, and any combinations thereof. According to some embodiments, the biostimulants or inoculants may comprise one or more Azospirillum (e.g., an extract of media comprising A. brasilense INTA Az-39), one or more Bradyrhizobium (e.g., an extract of media comprising B. elkanii SEMIA 501, B. elkanii SEMIA 587, B. elkanii SEMIA 5019, B. japonicum NRRL B-50586 (also deposited as NRRL B-59565), B. japonicum NRRL B-50587 (also deposited as NRRL B-59566), Bacillus amyloliquefaciens TJ1000 (also known as 1BE, isolate ATCC BAA-390), B. japonicum NRRL B-50588 (also deposited as NRRL B-59567), B. japonicum NRRL B-50589 (also deposited as NRRL B-59568), B. japonicum NRRL B-50590 (also deposited as NRRL B-59569), B. japonicum NRRL B-50591 (also deposited as NRRL B-59570), Trichoderma virens Gl-3 (ATCC 57678), Trichoderma virens Gl-21 (Thermo Trilogy Corporation, Wasco, CA), Trichoderma virens Gl-3 and Bacillus amyloliquefaciens LZB24, Trichoderma virens Gl-3 and Bacillus amyloliquefaciens NRRL B-50349, Trichoderma virens Gl-3 and Bacillus amyloliquefaciens TJ1000, Trichoderma virens Gl-21 and Bacillus amyloliquefaciens LZB24, Trichoderma virens Gl-21 and Bacillus amyloliquefaciens NRRL B-50349, Trichoderma virens Gl-21 and Bacillus amyloliquefaciens TJ1000, Trichoderma viride TRIECO® (Ecosense Labs. (India) Pvt. Ltd., India, BIO-CURE® L from T. Stanes & Co. Ltd., Indien), Trichoderma viride TV1 (Agribiotec srl, Italy), Trichoderma viride ICC080, and/or Ulocladium oudemansii HRU3 (BOTRY-ZEN®, Botry-Zen Ltd, NZ),, B. japonicum NRRL B-50592 (also deposited as NRRL B-59571), B. japonicum NRRL B-50593 (also deposited as NRRL B-59572), B. japonicum NRRL B-50594 (also deposited as NRRL B-50493), B. japonicum NRRL B-50608, B. japonicum NRRL B-50609, B. japonicum NRRL B-50610, B. japonicum NRRL B-50611, B. japonicum NRRL B-50612, B. japonicum NRRL B-50726, B. japonicum NRRL B-50727, B. japonicum NRRL B-50728, B. japonicum NRRL B-50729, B. japonicum NRRL B-50730, B. japonicum SEMIA 566, B. japonicum SEMIA 5079, B. japonicum SEMIA 5080, B. japonicum USDA 6, B. japonicum USDA 110, B. japonicum USDA 122, B. japonicum USDA 123, B. japonicum USDA 127, B. japonicum USDA 129 and/or B. japonicum USDA 532C), one or more Rhizobium extracts (e.g., an extract of media comprising R. leguminosarum S012A-2), one or more Sinorhizobium extracts (e.g., an extract of media comprising S. fredii CCBAU114 and/or S. fredii USDA 205), one or more Penicillium extracts (e.g., an extract of media comprising P. bilaiae ATCC 18309, P. bilaiae ATCC 20851, P. bilaiae ATCC 22348, P. bilaiae NRRL 50162, P. bilaiae NRRL 50169, P. bilaiae NRRL 50776, P. bilaiae NRRL 50777, P. bilaiae NRRL 50778, P. bilaiae NRRL 50777, P. bilaiae NRRL 50778, P. bilaiae NRRL 50779, P. bilaiae NRRL 50780, P. bilaiae NRRL 50781, P. bilaiae NRRL 50782, P. bilaiae NRRL 50783, P. bilaiae NRRL 50784, P. bilaiae NRRL 50785, P. bilaiae NRRL 50786, P. bilaiae NRRL 50787, P. bilaiae NRRL 50788, P. bilaiae RS7B-SD1, P. brevicompactum AgRF18, P. canescens ATCC 10419, P. expansum ATCC 24692, P. expansum YT02, P. fellatanum ATCC 48694, P. gaestrivorus NRRL 50170, P. glabrum DAOM 239074, P. glabrum CBS 229.28, P. janthinellum ATCC 10455, P. lanosocoeruleum ATCC 48919, P. radicum ATCC 201836, P. radicum FRR 4717, P. radicum FRR 4719, P. radicum N93/47267 and/or P. raistrickii ATCC 10490), one or more Pseudomonas extracts (e.g., an extract of media comprising P. jessenii PS06), one or more acaricidal, insecticidal and/or nematicidal extracts (e.g., an extract of media comprising Bacillus firmus 1-1582, Bacillus mycoides AQ726, NRRL B-21664; Beauveria bassiana ATCC-74040, Beauveria bassiana ATCC-74250, Burkholderia sp. A396 sp. Nov. rinojensis, NRRL B-50319, Chromobacterium subtsugae NRRL B-30655, Chromobacterium vaccinii NRRL B-50880, Flavobacterium H492, NRRL B-50584, Metarhizium anisopliae F52 (also known as Metarhizium anisopliae strain 52, Metarhizium anisopliae strain 7, Metarhizium anisopliae strain 43 and Metarhizium anisopliae BIO-1020, TAE-001; deposited as DSM 3884, DSM 3885, ATCC 90448, SD 170 and ARSEF 7711) and/or Paecilomyces fumosoroseus FE991), and/or one or more fungicidal extracts (e.g., an extract of media comprising Ampelomyces quisqualis AQ 10® (Intrachem Bio GmbH & Co. KG, Germany), Aspergillus flavus AFLA-GUARD® (Syngenta Crop Protection, Inc., CH), Aureobasidium pullulans BOTECTOR® (bio-ferm GmbH, Germany), Bacillus pumilus AQ717 (NRRL B-21662), Bacillus pumilus NRRL B-30087, Bacillus AQ175 (ATCC 55608), Bacillus AQ177 (ATCC 55609), Bacillus subtilis AQ713 (NRRL B-21661), Bacillus subtilis AQ743 (NRRL B-21665), Bacillus amyloliquefaciens FZB24, Bacillus amyloliquefaciens NRRL B-50349, Bacillus amyloliquefaciens TJ1000 (also known as 1BE, isolate ATCC BAA-390), Bacillus thuringiensis AQ52 (NRRL B-21619), Candida oleophila 1-82 (e.g., ASPIRE® from Ecogen Inc., USA), Candida saitoana BIOCURE® (in mixture with lysozyme; BASF, USA) and BIOCOAT® (ArystaLife Science, Ltd., Cary, NC), Clonostachys rosea f. catenulata (also referred to as Gliocladium catenulatum) J1446 (PRESTOP®, Verdera, Finland), Coniothyrium minitans CONTANS® (Prophyta, Germany), Cryphonectria parasitica (CNICM, France), Cryptococcus albidus YIELD PLUS® (Anchor Bio-Technologies, South Africa), Fusarium oxysporum BIOFOX® (from S.I. A.P. A., Italy) and FUSACLEAN® (Natural Plant Protection, France), Metschnikowia fructicola SHEMER® (Agrogreen, Israel), Microdochium dimerum ANHBOT® (Agrauxine, France), Muscodor albus NRRL 30547, Muscodor roseus NRRL 30548, Phlebiopsis gigantea ROTSOP® (Verdera, Finland), Pseudozyma flocculosa SPORODEX® (Plant Products Co. Ltd., Canada), Pythium oligandrum DV74 (POLYVERSUM®, Remeslo SSRO, Biopreparaty, Czech Rep.), Reynoutria sachlinensis (e.g., REGALIA® from Marrone BioInnovations, USA), Streptomyces NRRL B-30145, Streptomyces M1064, Streptomyces galbus NRRL 30232, Streptomyces lydicus WYEC 108 (ATCC 55445), Streptomyces violaceusniger YCED 9 (ATCC 55660; DE-THATCH-9®, DECOMP-9® and THATCH CONTROL®, Idaho Research Foundation, USA), Streptomyces WYE 53 (ATCC 55750; DE-THATCH-9®, DECOMP-9® and THATCH CONTROL®, Idaho Research Foundation, USA), Talaromyces flavus Y 117b (PROTUS®, Prophyta, Germany), Trichoderma asperellum SKT-1 (ECO-HOPE®, Kumiai Chemical Industry Co., Ltd., Japan), Trichoderma atroviride LC52 (SENTINEL®, Agrimm Technologies Ltd, NZ), Trichoderma harzianum T-22 (PLANTSHIELD®, der Firma BioWorks Inc., USA), Trichoderma harzianum TH-35 (ROOT PRO®, from Mycontrol Ltd., Israel), Trichoderma harzianum T-39 (TRICHODEX®), Mycontrol Ltd., Israel; TRICHODERMA 2000®, Makhteshim Ltd., Israel), Trichoderma harzianum ICC012 and Trichoderma viride TRICHOPEL (Agrimm Technologies Ltd, NZ), Trichoderma harzianum ICC012 and Trichoderma viride ICC080 (REMEDIER® WP, Isagro Ricerca, Italy), Trichoderma polysporum and Trichoderma harzianum (BINAB®, BINAB Bio-Innovation AB, Sweden), Trichoderma stromaticum TRICOVAB® (C.E. P.L. A.C., Brazil), Trichoderma virens GL-21 (SOILGARD®, Certis LLC, USA), Trichoderma virens Gl-3, ATCC 57678, Trichoderma virens Gl-21 (Thermo Trilogy Corporation, Wasco, CA), Trichoderma virens G1-3 and Bacillus amyloliquefaciens FZB2, Trichoderma virens Gl-3 and Bacillus amyloliquefaciens NRRL B-50349, Trichoderma virens Gl-3 and Bacillus amyloliquefaciensTJ1000, Trichoderma virens Gl-21 and Bacillus amyloliquefaciens FZB24, Trichoderma virensGl-21 and Bacillus amyloliquefaciens NRRL B-50349, Trichoderma virens Gl-21 and Bacillus amyloliquefaciens TJ1000, Trichoderma viride TRIECO® (Ecosense Labs. (India) Pvt. Ltd., Indien, BIO-CURE® F from T. Stanes & Co. Ltd., Indien), Trichoderma viride TV1 (Agribiotec srl, Italy), Trichoderma viride ICC080, and/or Ulocladium oudemansii HRU3 (BOTRY-ZEN®, Botry-Zen Ltd, NZ)), and combinations thereof.

In some embodiments, the seed treatment active may include one or more beneficial microbes. Non-limiting examples of such microbes include beneficial microbes selected from the following genera: Actinomycetes, Agrobacterium, Arthrobacter, Alcaligenes, Acinetobacter spp., Azospirillum spp., Aureobacterium, Azobacter, Azorhizobium, Bacillus, Beijerinckia, Bradyrhizobium, Brevibacillus, Burkholderia, Chromobacterium, Chryseomonasspp., Clostridium, Clavibacter, Comamonas, Corynebacterium, Curtobacterium, Enterobacter, Eupenicillium spp., Exiguobacterium spp., Flavobacterium, Gluconobacter, Hydrogenophaga, Hymenoscyphous, Klebsiella, Kluyvera spp., Methylobacterium, Paenibacillus, Pasteuria, Photorhabdus, Phyllobacterium, Pseudomonas, Rhizobium, Rhizobacter, Rhizopogon, Serratia, Sinorhizobium, Sphingobacterium, Swaminathania spp., Stenotrophomonas, Streptomyces spp., Thiobacillus, Variovorax, Vibrio, Xanthobacter, Xanthomonas and Xenorhabdus, or any combination thereof. According to some embodiments, the seed treatment active comprises one or more of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium subtsugae, Pasteuria penetrans, Pasteuria usage, and Pseudomona fluorescens. According to some embodiments, a microbe may comprise a fungus of the genus Alternaria, Ampelomyces, Arthrobotrys spp., Aspergillus, Aureobasidium, Beauveria, Candida spp., Colletotrichum, Coniothyrium, Gigaspora spp,. Gliocladium, Glomus spp., Laccaria spp., Metarhizium, Mucor spp., Muscodor, Oidiodendron spp., Paecilomyces, Penicillium spp., Pisolithus spp., Scleroderma, Trichoderma, Typhula, Ulocladium, and Verticillium. In another aspect, a fungus is Beauveria bassiana, Coniothyrium minitans, Gliocladium virens, Muscodor albus, Paecilomyces lilacinus, or Trichoderma polysporum.

In some embodiments, the seed treatment active may include one or more lipo-chitooligosaccharides (LCOs), chitin oligomer(s) and/or chitosan oligomer(s) (collectively referred to hereinafter as Cos), and/or chitinous compounds. LCOs, sometimes referred to as symbiotic nodulation (Nod) signals (or Nod factors) or as Myc factors, consist of an oligosaccharide backbone of β-1,4-linked N-acetyl-D-glucosamine (“GlcNAc”) residues with an N-linked fatty acyl chain condensed at the non-reducing end. As understood in the art, LCOs differ in the number of GlcNAc residues in the backbone, in the length and degree of saturation of the fatty acyl chain and in the substitutions of reducing and non-reducing sugar residues. See, e.g., Denarie et al, Ann. Rev. Biochem. 65:503 (1996); Diaz et al, Mol. Plant-Microbe Interactions 13:268 (2000); Hungria et al, Soil Biol. Biochem. 29:819 (1997); Hamel et al, Planta 232:787 (2010); and Prome et al, Pure & Appl. Chem. 70(1):55 (1998), the contents and disclosures of which are incorporated herein by reference.

LCOs may be synthetic or obtained from any suitable source. See, e.g., WO 2005/063784, WO 2007/117500 and WO 2008/071674, the contents and disclosures of which are incorporated herein by reference. In some aspects, a synthetic LCO may have the basic structure of a naturally occurring LCO but contains one or more modifications or substitutions, such as those described in Spaink, Crit. Rev. Plant Sci. 54:257 (2000). LCOs and precursors for the construction of LCOs (e.g., Cos, which may themselves be useful as a biologically active ingredient) can be synthesized by genetically engineered organisms. See, e.g., Samain et al., Carbohydrate Res. 302:35 (1997); Cottaz et al., Meth. Eng. 7(4):311 (2005); and Samain et al., J. Biotechnol. 72:33 (1999) (e.g., FIG. 1 therein, which shows structures of Cos that can be made recombinantly in E. coli harboring different combinations of genes nodBCHL), the contents and disclosures of which are incorporated herein by reference.

LCOs (and derivatives thereof) may be included or utilized in compositions in various forms of purity and can be used alone or in the form of a culture of LCO-producing bacteria or fungi. For example, OPTIMIZE® (commercially available from Monsanto Company (St. Louis, MO)) contains a culture of Bradyrhizobium japonicum that produces LCO. Methods to provide substantially pure LCOs include removing the microbial cells from a mixture of LCOs and the microbe, or continuing to isolate and purify the LCO molecules through LCO solvent phase separation followed by HPLC chromatography as described, for example, in U.S. Pat. No. 5,549,718. Purification can be enhanced by repeated HPLC and the purified LCO molecules can be freeze-dried for long-term storage. According to some embodiments, the LCO(s) included in compositions of the present disclosure is/are at least 0.1%, 0.5%, 1%, 2%, 3%, 4%, 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99% or 100% pure. Compositions and methods in some embodiments may comprise analogues, derivatives, hydrates, isomers, salts and/or solvates of LCOs. LCOs may be incorporated into compositions of the present disclosure in any suitable amount(s)/concentration(s). For example, compositions of the present disclosure comprise about 1×⁻²⁰ M to about 1×⁻¹ M LCO(s). For example, compositions of the present disclosure can comprise about 1×⁻²⁰ M, 1×⁻¹⁹ M, 1×⁻¹⁸ M, 1×⁻¹⁷ M, 1×⁻¹⁶ M, 1×⁻¹⁵ M, 1×⁻¹⁴ M, 1×⁻¹³ M, 1×⁻¹² M, 1×⁻¹¹ M, 1×⁻¹⁰ M, 1×⁻⁹ M, 1×⁻⁸M, 1×⁻⁷M, 1×⁻⁶ M, 1×⁻⁵ M, 1×⁻⁴M, 1×⁻³ M, 1×⁻² M, or 1×⁻¹ M of one or more LCOs. In an aspect, the LCO concentration is 1×⁻¹⁴ M to 1×⁻⁵ M, 1×⁻¹² M to 1×⁻⁶ M, or 1×⁻¹⁰ M to 1×⁻⁷ M. The amount/concentration of LCO may be an amount effective to impart a positive trait or benefit to a plant, such as to enhance the disease resistance, growth and/or yield of the plant to which the composition is applied. According to some embodiments, the LCO amount/concentration is not effective to enhance the yield of the plant without beneficial contributions from one or more other constituents of the composition, such as CO and/or one or more pesticides.

In some embodiments, the seed treatment active may include one or more chitin oligomers and/or chitosan oligomers. See, e.g., D'Haeze et al., Glycobiol. 12(6): 79R (2002); Demont-Caulet et al., Plant Physiol. 120(1):83 (1999): Hanel et al. Planta 232:787 (2010); Muller et al., Plant Physiol. 124:733 (2000); Robina et al., Tetrahedron 58:521-530 (2002); Rouge et al., Docking of Chitin Oligomers and Nod Factors on Lectin Domains of the LysM-RLK Receptors in the Medicago-Rhizobium Symbiosis, in The Molecular Immunology of Complex Carbohydrates-3 (Springer Science, 2011); Van der Holst et al., Curr. Opin. Struc. Biol. 11:608 (2001); and Wan et al., Plant Cell 21:1053 (2009), the contents and disclosures of which are incorporated by reference. Cos may be obtained from any suitable source. For example, Cos may be derived from an LCO. For example, in an aspect, compositions comprise one or more Cos derived from an LCO obtained (i.e., isolated and/or purified) from a strain of Azorhizohium, Bradyrhizohium (e.g., B. japonicum), Mesorhizobium, Rhizobium (e.g., R. leguminosarum), Sinorhizobium (e.g., S. meliloti), or mycorhizzal fungi (e.g., Glomus intraradicus). Alternatively, the CO may be synthetic. Methods for the preparation of recombinant Cos are known in the art. See, e.g., Cottaz et al., Meth. Eng. 7(4): 311 (2005); Samain et al., Carbohydrate Res. 302:35 (1997); and Samain et al., J. Biotechnol. 72:33 (1999), the contents and disclosures of which are incorporated herein by reference.

Cos (and derivatives thereof) may be included or utilized in compositions in various forms of purity and can be used alone or in the form of a culture of CO-producing bacteria or fungi. According to some embodiments, the CO(s) included in compositions may be at least 0.1%, 0.5%, 1%, 2%, 3%, 4%, 5%, 6%, 7%, 8%, 9%, 10%, 15%, 20%, 30%, 40%, 50%, 60%, 70%, 75%, 80%, 85%, 90%, 91%, 92%, 93%, 94%, 95%, 96%, 97%, 98%, 99%, 99.5% or more pure. It is to be understood that compositions and methods of the present disclosure can comprise hydrates, isomers, salts and/or solvates of Cos. Cos in some embodiments may be incorporated into compositions in any suitable amount(s)/concentration(s). For example, compositions in some embodiments may comprise about 1×10⁻²⁰ M to about 1×10⁻¹ M Cos, such as about 1×10⁻²⁰ M, 1×10⁻¹⁹ M, 1×10⁻¹⁸ M, 1×10⁻¹⁷ M, 1×10⁻¹⁶ M, 1×10⁻¹⁵ M, 1×10⁻¹⁴ M, 1×10⁻¹³ M, 1×10⁻¹² M, 1×10⁻¹¹ M, 1×10⁻¹⁰ M, 1×10⁻⁹ M, 1×10⁻⁸ M, 1×10⁻⁷ M, 1×10⁻⁶ M, 1×10⁻⁵ M, 1×10⁻⁴M, 1×10⁻³ M, 1×10⁻² M, or 1×10⁻¹ M of one or more Cos. For example, the CO concentration may be 1×10⁻¹⁴ M to 1×10⁻⁵ M, 1×10⁻¹² M to 1×10⁻⁶ M, or 1×10⁻¹⁰ M to 1×10⁻⁷ M. The amount/concentration of CO may be an amount effective to impart or confer a positive trait or benefit to a plant, such as to enhance the soil microbial environment, nutrient uptake, or increase the growth and/or yield of the plant to which the composition is applied. Compositions in some embodiments may comprise one or more suitable chitinous compounds, such as, for example, chitin (IUPAC: N-[5-[[3-acetylamino-4,5-dihydroxy-6-(hydroxymethyl)oxan-2yl]methoxymethyl]-2-[[5-acetylamino-4,6-dihydroxy-2-(hydroxymethyl)oxan-3-yl]methoxymethyl]- 4-hydroxy-6-(hydroxymethyl)oxan-3-ys]ethanamide), chitosan (IUPAC: 5-amino-6-[5-amino-6-[5-amino-4,6-dihydroxy-2(hydroxymethyl)oxan-3-yl]oxy-4-hydroxy-2-(hydroxymethyl)oxan-3-yl]oxy-2(hydroxymethyl)oxane-3,4- diol), and isomers, salts and solvates thereof.

Chitins and chitosans, which are major components of the cell walls of fungi and the exoskeletons of insects and crustaceans, are composed of GlcNAc residues. Chitins and chitosans may be obtained commercially or prepared from insects, crustacean shells, or fungal cell walls. Methods for the preparation of chitin and chitosan are known in the art. See, e.g., U.S. Pat. No. 4,536,207 (preparation from crustacean shells) and U.S. Pat. No. 5,965,545 (preparation from crab shells and hydrolysis of commercial chitosan); and Pochanavanich et al., Lett. Appl. Microbiol. 35:17 (2002) (preparation from fungal cell walls).

Deacetylated chitins and chitosans may be obtained that range from less than 35% to greater than 90% deacetylation and cover a broad spectrum of molecular weights, e.g., low molecular weight chitosan oligomers of less than 15 kD and chitin oligomers of 0.5 to 2 kD; “practical grade” chitosan with a molecular weight of about 15 kD; and high molecular weight chitosan of up to 70 kD. Chitin and chitosan compositions formulationted for seed treatment are commercially available. Commercial products include, for example, ELEXA® (Plant Defense Boosters, Inc.) and BEYOND™ (Agrihouse, Inc.).

In some embodiments, the seed treatment active may comprise one or more suitable flavonoids, including, but not limited to, anthocyanidins, anthoxanthins, chalcones, coumarins, flavanones, flavanonols, flavans and isoflavonoids, as well as analogues, derivatives, hydrates, isomers, polymers, salts and solvates thereof. Flavonoids are phenolic compounds having the general structure of two aromatic rings connected by a three-carbon bridge. Classes of flavonoids are known in the art. See, e.g., Jain et al., J. Plant Biochem. & Biotechnol. 11:1 (2002); and Shaw et al., Environ. Microbiol. 11:1867 (2006), the contents and disclosures of which are incorporated herein by reference. Several flavonoid compounds are commercially available. Flavonoid compounds may be isolated from plants or seeds, e.g., as described in U.S. Pat. Nos. 5,702,752; 5,990,291; and 6,146,668. Flavonoid compounds may also be produced by genetically engineered organisms, such as yeast, See, e.g., Ralston et al., Plant Physiol. 137:1375 (2005).

The seed treatment active may include one or more flavanones, such as one or more of butin, eriodictyol, hesperetin, hesperidin, homoeriodictyol, isosakuranetin, naringenin, naringin, pinocembrin, poncirin, sakuranetin, sakuranin, and/or sterubin, one or more flavanonols, such as dihydrokaempferol and/or taxifolin, one or more flavans, such as one or more flavan-3-ols (e.g., catechin (C), catechin 3-gallate (Cg), epicatechins (EC), epigallocatechin (EGC) epicatechin 3-gallate (Ecg), epigallcatechin 3-gallate (EGCg), epiafzelechin, fisetinidol, gallocatechin (GC), gallcatechin 3-gallate (GCg), guibourtinidol, mesquitol, robinetinidol, theaflavin-3-gallate, theaflavin-3′-gallate, theflavin-3,3′-digallate, thearubigin), flavan-4-ols (e.g., apiforol and/or luteoforol) and/or flavan-3,4-diols (e.g., leucocyanidin, leucodelphinidin, leucofisetinidin, leucomalvidin, luecopelargonidin, leucopeonidin, leucorobinetinidin, melacacidin and/or teracacidin) and/or dimers, trimers, oligomers and/or polymers thereof (e.g., one or more proanthocyanidins), one or more isoflavonoids, such as one or more isoflavones or flavonoid derivatives (e.g., biochanin A, daidzein, formononetin, genistein and/or glycitein), isoflavanes (e.g., equol, ionchocarpane and/or laxifloorane), isoflavandiols, isoflavenes (e.g., glabrene, haginin D and/or 2-methoxyjudaicin), coumestans (e.g., coumestrol, plicadin and/or wedelolactone), pterocarpans, roetonoids, neoflavonoids (e.g., calophyllolide, coutareagenin, dalbergichromene, dalbergin, nivetin), and/or pterocarpans (e.g., bitucarpin A, bitucarpin B, erybraedin A, erybraedin B, erythrabyssin II, erthyrabissin-1, erycristagallin, glycinol, glyceollidins, glyceollins, glycyrrhizol, maackiain, medicarpin, morisianine, orientanol, phaseolin, pisatin, striatine, trifolirhizin), and combinations thereof. Flavonoids and their derivatives may be included in compositions in any suitable form, including, but not limited to, polymorphic and crystalline forms. Flavonoids may be included in compositions in any suitable amount(s) or concentration(s). The amount/concentration of a flavonoid(s) may be an amount effective, which may be indirectly through activity on soil microorganisms or other means, such as to enhance plant nutrition and/or yield. According to some embodiments, a flavonoid amount/concentration may not be effective to enhance the nutrition or yield of the plant without the beneficial contributions from one or more other ingredients of the composition, such as LCO, CO, and/or one or more pesticides.

In some embodiments, the seed treatment active may comprise one or more non-flavonoid nod-gene inducer(s), including, but not limited to, jasmonic acid ([1II-[1a,2b(Z)]]-3-oxo-2-(pentenyl)cyclopentaneacetic acid; JA), linoleic acid ((Z, Z)-9,12-Octadecadienoic acid) and/or linolenic acid ((Z, Z, Z)-9,12,15-octadecatrienoic acid), and analogues, derivatives, hydrates, isomers, polymers, salts and solvates thereof. Jasmonic acid and its methyl ester, methyl jasmonate (MeJA), collectively known as jasmonates, are octadecanoid-based compounds that occur naturally in some plants (e.g., wheat), fungi (e.g., Botryodiplodia theobromae, Gibbrella fujikuroi), yeast (e.g., Saccharomyces cerevisiae) and bacteria (e.g., Escherichia coli). Linoleic acid and linolenic acid may be produced in the course of the biosynthesis of jasmonic acid.

Derivatives of jasmonic acid, linoleic acid, and linolenic acid that may be included or used in compositions in some embodiments include esters, amides, glycosides and salts thereof. Representative esters are compounds in which the carboxyl group of linoleic acid, linolenic acid, or jasmonic acid has been replaced with a —COR group, where R is an —OR¹ group, in which R¹ is: an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Representative amides are compounds in which the carboxyl group of linoleic acid, linolenic acid, or jasmonic acid has been replaced with a —COR group, where R is an NR²R³ group, in which R² and R³ are each independently: a hydrogen; an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Esters may be prepared by known methods, such as acid-catalyzed nucleophilic addition, wherein the carboxylic acid is reacted with an alcohol in the presence of a catalytic amount of a mineral acid. Amides may also be prepared by known methods, such as by reacting the carboxylic acid with the appropriate amine in the presence of a coupling agent, such as dicyclohexyl carbodiimide (DCC), under neutral conditions. Suitable salts of linoleic acid, linolenic acid and jasmonic acid include, for example, base addition salts. The bases that may be used as reagents to prepare metabolically acceptable base salts of these compounds include those derived from cations such as alkali metal cations (e.g., potassium and sodium) and alkaline earth metal cations (e.g., calcium and magnesium). These salts may be readily prepared by mixing a solution of linoleic acid, linolenic acid, or jasmonic acid with a solution of the base. The salts may be precipitated from solution and collected by filtration, or may be recovered by other means such as by evaporation of the solvent.

In some embodiments, the seed treatment active may comprise one or more plant growth regulators including, but not limited to, ethephon and/or thidiazuron.

In some embodiments, the seed treatment active may comprise one or more karrakins, including but not limited to 2H-furo[2,3-c]pyran-2-ones, as well as analogues, derivatives, hydrates, isomers, polymers, salts and solvates thereof. Examples of biologically acceptable salts of karrakins include acid addition salts formed with biologically acceptable acids, examples of which include hydrochloride, hydrobromide, sulphate or bisulphate, phosphate or hydrogen phosphate, acetate, benzoate, succinate, fumarate, maleate, lactate, citrate, tartrate, gluconate; methanesulphonate, benzene sulphonate and p-toluenesulphonic acid. Additional biologically acceptable metal salts may include alkali metal salts, with bases, examples of which include the sodium and potassium salts. Karrakins may be incorporated into compositions in any suitable amount(s) or concentration(s). For example, the amount/concentration of a karrakin may be an amount or concentration effective to impart or confer a positive trait or benefit to a plant, such as to enhance the disease resistance, growth and/or yield of the plant to which the composition is applied. In an aspect, a karrakin amount/concentration may not be effective to enhance the disease resistance, growth and/or yield of the plant without beneficial contributions from one or more other ingredients of the composition, such as a LCO, CO and/or one or more pesticides.

In some embodiments, the seed treatment active may comprise one or more anthocyanidins and/or anthoxanthins, such as one or more of cyanidin, delphinidin, malvidin, pelargonidin, peonidin, petunidin, flavones (e.g., apigenin, baicalein, chrysin, 7,8-dihydroxyflavone, diosmin, flavoxate, 6-hydroxyflavone, luteolin, scutellarein, tangeritin and/or wogonin) and/or flavonols (e.g., amurensin, astragalin, azaleatin, azalein, fisetin, furanoflavonols galangin, gossypetin, 3-hydroxyflavone, hypcroside, icariin, isoquercetin, kacmpferide, kaempferitrin, kaempferol, isorhamnetin, morin, myricetin, myricitrin, natsudaidain, pachypodol, pyranoflavonols quercetin, quericitin, rhamnazin, rhamnetin, robinin, rutin, spiraeoside, troxerutin and/or zanthorhamnin), and combinations thereof.

In some embodiments, the seed treatment active may include one or more gluconolactone and/or an analogue, derivative, hydrate, isomer, polymer, salt and/or solvate thereof. Gluconolactone may be incorporated into compositions in any suitable amount(s)/concentration(s). For example, the amount/concentration of a gluconolactone amount/concentration may be an amount effective to impart or confer a positive trait or benefit to a plant, such as to enhance the disease resistance, growth and/or yield of the plant to which the composition is applied. In an aspect, the gluconolactone amount/concentration may not be effective to enhance the disease resistance, growth and/or yield of the plant without beneficial contributions from one or more other ingredients of the composition, such as a LCO, CO and/or one or more pesticides.

In some embodiments, the seed treatment active may include one or more nutrient(s) and/or fertilizer(s), such as organic acids (e.g., acetic acid, citric acid, lactic acid, malic acid, taurine, etc.), macrominerals (e.g., phosphorous, calcium, magnesium, potassium, sodium, iron, etc.), trace minerals (e.g., boron, cobalt, chloride, chromium, copper, fluoride, iodine, iron, manganese, molybdenum, selenium, zinc, etc.), vitamins, (e.g., vitamin A, vitamin B complex (i.e., vitamin Bi, vitamin B2, vitamin B3, vitamin B5, vitamin Br,. Vitamin B7, vitamin Bx. Vitamin B9, vitamin Bn, choline) vitamin C, vitamin D, vitamin E, vitamin K.), and/or carotenoids (α-carotene, β-carotene, carotene, cryptoxanthin, lutein, lycopene, zeaxanthin, etc.), and combinations thereof. In an aspect, compositions of the present disclosure may comprise macro-and micronutrients of plants or microbes, including phosphorous, boron, chlorine, copper, iron, manganese, molybdenum and/or zinc. According to some embodiments, compositions may comprise one or more beneficial micronutrients. Non-limiting examples of micronutrients for use in compositions described herein may include vitamins, (e.g., vitamin A, vitamin B complex (i.e., vitamin B1, vitamin B2, vitamin B3, vitamin B5, vitamin B6, vitamin B7, vitamin B8, vitamin B9, vitamin B 12, choline) vitamin C, vitamin D, vitamin E, vitamin K, carotenoids (α-carotene, β-carotene, cryptoxanthin, lutein, lycopene, zeaxanthin, etc.), macrominerals (e.g., phosphorous, calcium, magnesium, potassium, sodium, iron, etc.), trace minerals (e.g., boron, cobalt, chloride, chromium, copper, fluoride, iodine, iron, manganese, molybdenum, selenium, zinc, etc.), organic acids (e.g., acetic acid, citric acid, lactic acid, malic aclid, taurine, etc.), and combinations thereof. In a particular aspect, compositions may comprise phosphorous, boron, chlorine, copper, iron, manganese, molybdenum, and/or zinc, and combinations thereof. For compositions comprising phosphorous, it is envisioned that any suitable source of phosphorous may be used. For example, phosphorus may be derived from a rock phosphate source, such as monoammonium phosphate, diammonium phosphate, monocalcium phosphate, super phosphate, triple super phosphate, and/or ammonium polyphosphate, an organic phosphorous source, or a phosphorous source capable of solubilization by one or more microorganisms (e.g., Penicillium bilaiae).

In view of the above, the seed treatment devices, systems and methods herein leverage bidirectionally configured baffles having concave surfaces to redirect seeds and treatment formulation in a mixing chamber, to thereby facilitate mixing of the seeds and the seed treatment formulation while substantially preventing seed treatment formulation residue build-up within the mixing chamber and/or removal of seed treatment formulation residue build-up in the mixing chamber. For example, when a rotor rotates in one direction, the configuration (e.g., shape, size, position, etc.) of one of the concave surfaces of fins redirect seeds and treatment formulation to facilitate mixing of the seeds and coating of the seed treatment formulation on the seeds, while also discouraging seed treatment formulation residue build-up. When the rotor rotates in the opposite direction, the configuration of the other (opposing) concave surfaces of the fins may assist in the removal of seed treatment formulation residue through the redirection of the seeds and treatment formulation. Further, the seed treatment devices, systems and methods herein leverage less baffles than conventional systems. From all of the above, production downtime for cleaning and removing build-up in the mixing chamber is decreased, and in some cases eliminated, as compared to conventional seed treatment devices.

In accordance with the foregoing, various embodiments of the present disclosure relate to methods of retrofitting seed treatment devices. Such methods typically involve removing, replacing, and/or reconfiguring one or more portions of the seed treatment device. For example, in certain embodiments, a method of retrofitting results in the seed treatment device having a lid as defined herein (e.g., including one or more baffles having concave surfaces). In certain embodiments, a retrofitting method involves removing a lid detachably coupled to the body of a seed treatment device to be replaced by a lid as defined in accordance with the present disclosure. Removal of the lid may further include removal of any clamps, attachment devices, etc. that had secured the previous lid to the device body. In certain embodiments, any or all of the clamps, attachment devices, etc. may be removed and replaced by clamps, attachment devices, etc. for use with the replacement lid. In these and certain other embodiments, any or all of the clamps, attachment devices, etc. may be reused or re-purposed (if necessary) for use with the replacement lid.

Embodiments of the present disclosure directed to retrofitting of seed treatment devices may also include removing, replacing, and/or reconfiguring the seed collector for receiving the seeds exiting the mixing chamber. This can include adjusting the exit opening (e.g., to render it better suited to communication with a replacement seed collector), and/or adjusting, replacing, etc. a door for covering the exit opening and optional door assembly components such as a pneumatic rod for actuating the door. For example, the pneumatic rod that actuates the door may be adjusted, replaced, etc. and mounted centrally within a discharge chute, and the door may be adjusted, replaced, etc. to pivot up and down rather than side-to-side as in a conventional seed treatment device. As such, in this example, the hinge point shifts from a right-hand or left-hand side (when viewed from outside the treatment device) to on top of, above, etc. the exit opening. This can also include removing, replacing or repurposing any attachment devices related to the seed collector. Such retrofitting may also include adjusting the seed collector, removing the seed collector, and/or replacing the seed collector with a replacement seed collector.

Embodiments of the present disclosure described herein provide suitable output of treated seeds suitable for use on a commercial scale during seed treatments as described herein. A seed treatment of the present disclosure may be measured from commencing rotation of the rotor or delivery of the seed treatment formulation to the mixing chamber to completion of collection of the treated seeds in the seed collector. Generally, a seed treatment may include operation of the rotor in a first direction for certain time interval and may also include operation of the rotor in a second, opposite direction for a certain time interval. Certain seed treatments may include one or more alternating intervals of operating the rotor in a first direction following by operation of the rotor in a second, opposite direction.

In various embodiments, suitable outputs of treated seeds can be achieved. For example, a batch of seeds may range from about 180 kg to about 200 kg. With that in mind, the seed treatment devices herein may be operable to complete a treatment process of at least one batch of seeds per minute. In other examples, the seed treatment devices herein may be operable to complete a treatment process of at least one batch per about forty seconds. The seed treatment devices herein may also be capable of continuous batch use such that after one batch is treaded and discharged, another batch is loaded for treatment thereafter with minimal (or no) delay. In such examples, the seed treatment devices may be operable to treat sixty batches or more per hour.

Baffles of the devices of the present disclosure are currently believed to contribute to various performance improvements. Overall, the baffles of the present disclosure may involve a lower exposed surface baffle surface area as compared to prior baffle designs.

Therefore, seed treatment methods of the present disclosure typically provide advantageous productivity in terms of treated seed productivity per hour per unit baffle surface area.

Further in accordance with the present disclosure, the baffle arrangement provides for improvements in cleaning of the baffles. Such improvements may be manifested in less process downtime and/or more efficient production of treated seeds. In this manner, the overall process may be operated more efficiently in terms of either in greater production of treated seeds per unit time or equivalent production of treated seeds as compared to methods utilizing prior seed treatment devices but requiring a seed treatment time of shorter duration.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A seed treatment device comprising:
a mixing chamber in which seeds and a seed treatment formulation are mixed when received therein, the mixing chamber having an interior portion and a vertical axis;
a body including an inner surface defining at least part of the mixing chamber;
a rotor positioned at least partly in the body and including an inner surface defining at least a lower portion of the mixing chamber, the rotor configured to rotate relative to the body about the vertical axis of the mixing chamber, to thereby cause the seeds in the lower portion of the mixing chamber to flow upwards along the inner surface of the rotor and along the inner surface of the body;
a lid detachably coupled to the body and defined by a perimeter edge, the lid including an inner face surface adjacent to the mixing chamber when the lid is coupled to the body; and
one or more baffles disposed in the mixing chamber, wherein each baffle of the one or more baffles comprises a first concave surface and a second concave surface both facing at least partly toward the interior portion of the mixing chamber, the first concave surface configured to redirect the seeds and the treatment formulation in the mixing chamber toward the interior portion of the mixing chamber when the rotor rotates in a first direction and the second concave surface configured to redirect the seeds and the treatment formulation in the mixing chamber toward the interior portion of the mixing chamber when the rotor rotates in a second direction opposite the first direction.

2. The seed treatment device of claim 1, wherein a shape of said each baffle is generally pyramidical.

3. The seed treatment device of claim 1, wherein the one or more baffles include from two to four baffles disposed in the mixing chamber.

4. The seed treatment device of claim 3, wherein the baffles each have substantially the same shape; and/or
wherein the baffles are approximately equally spaced about the mixing chamber.

5. (canceled)

6. The seed treatment device of claim 4, wherein the lid defines openings configured to allow ingress of seed stock, treatment composition, finishing powders, and/or any additional materials used in a treatment process, and wherein the baffles are spaced about the mixing chamber with clearances for the openings.

7. The seed treatment device of claim 1, wherein the body includes an annular upper inner surface; and
wherein at least one of the first concave surface and the second concave surface of said each baffle has a radius of curvature of between about 25 percent and about 60 percent of a radius of curvature of the annular upper inner surface of the body.

8. (canceled)

9. The seed treatment device of claim 1, wherein the body includes an annular upper inner surface; and
wherein the rotor includes a concave inner surface below the annular upper inner surface of the body.

10. The seed treatment device of claim 1, wherein said each baffle includes an edge, wherein the first concave surface and the second concave surface adjoin along the edge, and wherein the first and second concave surfaces are mirrored relative to the edge.

11. (canceled)

12. The seed treatment device of claim 1, wherein at least one of the first concave surface and the second concave surface includes a compound surface having two or more sections.

13. The seed treatment device of claim 1, wherein said each baffle is coupled to the inner surface of the lid, and wherein the first concave surface and the second concave surface of said each baffle face away from the inner surface of the lid.

14. (canceled)

15. The seed treatment device of claim 13, wherein said each baffle is configured to provide a smooth transition between at least one of the first concave surface and the second concave surface and the inner surface of the lid.

16. The seed treatment device of claim 1, wherein said each baffle is coupled to the inner surface of the body, and wherein the first concave surface and the second concave surface of said each baffle face away from the inner surface of the body.

17-18. (canceled)

19. The seed treatment device of claim 1, wherein the body defines an exit opening in communication with the mixing chamber and configured to allow the seeds to exit the mixing chamber.

20. (canceled)

21. The seed treatment device of claim 1, wherein the lid defines at least a first inlet opening and a second inlet opening each in communication with the mixing chamber, wherein the first inlet opening is configured to receive the seeds, and wherein the second inlet opening is configured to receive the seed treatment formulation.

22. The seed treatment device of claim 1, wherein the rotor is configured to rotate in a first direction or a second direction opposite the first direction.

23. A method of treating seeds in a seed treatment device, wherein the seed treatment device includes a mixing chamber for mixing seeds and treatment formulations, the method comprising:
delivering seeds into the mixing chamber of the seed treatment device;
rotating, relative to the body, the rotor in a first direction about the vertical axis, thereby causing the seeds within the mixing chamber to flow upward;
delivering a seed treatment formulation into the mixing chamber, thereby treating the seeds with the seed treatment formulation; and
rotating, relative to the body, the rotor in a second direction opposite the first direction about the vertical axis.

24. The method of claim 23, further comprising:
directing, by a first concave surface of a baffle disposed in the mixing chamber, the seeds and the seed treatment formulation generally inward and generally downward relative to the mixing chamber, when the rotor is rotating in the first direction; and
directing, by a second concave surface of the baffle, the seeds and the seed treatment formulation generally inward and generally downward relative to the mixing chamber, when the rotor is rotating in the second direction.

25. The method of claim 23, wherein rotating the rotor in the second direction includes reversing a polarity of a motor actuating the rotor.

26. The method of claim 23, wherein delivering the seeds into the mixing chamber, rotating the rotor in the first direction, and delivering the seed treatment formulation into the mixing chamber are steps of a seed treatment, and wherein rotating the rotor in the second direction is implemented after a predetermined number of seed treatments.

27. The method of claim 23, further comprising delivering forced air into the mixing chamber.

28. (canceled)
